(19) United States
(12) Patent Application Publication
(10) Pub. No.: US 2026/0115906 A1
(43) Pub. Date: Apr. 30, 2026

(54) GENERATING GRASP POSES FOR CONTROLLING ROBOTS USING DIFFUSION MODELS

(71) Applicant: NVIDIA CORPORATION, Santa Clara, CA (US)

(72) Inventors: Adithyavairavan MURALI, Seattle, WA (US); Yu-Wei CHAO, Redmond, WA (US); Clemens EPPNER, Seattle, WA (US); Balakumar SUNDARALINGAM, San Jose, CA (US); Fabio TOZETO RAMOS, Seattle, WA (US); Dieter FOX, Seattle, WA (US)

(21) Appl. No.: 19/266,798

(22) Filed: Jul. 11, 2025

Related U.S. Application Data
(60) Provisional application No. 63/713,898, filed on Oct. 30, 2024.

(51) Int. Cl. B25J 9/16

(52) U.S. Cl. CPC B25J 9/163; B25J 9/161; B25J 9/1612; G05B 2219/39001

(57) ABSTRACT

The disclosed method for controlling a robot to grasp an object includes receiving sensor data from one or more sensors, generating, based on the sensor data and using a first trained machine learning model, one or more grasp poses, selecting, from the one or more grasp poses and using a first trained machine learning model, one or more filtered grasp poses, generating, based on the one or more filtered grasp poses, a grasping plan, and causing the robot to grasp the object based on the grasping plan.

### CROSS-REFERENCE TO RELATED APPLICATIONS

This application claims priority benefit of the United States Provisional Patent Application titled, “IMPROVED DIFFUSION MODEL FOR SIX DEGREES OF FREEDOM ANTIPODAL GRASPING WITH A DISCRIMINATOR,” filed on Oct. 30, 2024, and having Ser. No. 63/713,898. The subject matter of this related application is hereby incorporated herein by reference.

### BACKGROUND

### Technical Field

Embodiments of the present disclosure relate generally to robotics, artificial intelligence, and machine learning, and, more specifically, to generating grasp poses for controlling robots using diffusion models.

### Description of the Related Art

Robots are increasingly being used to perform physical tasks that involve interacting with objects, such as picking, placing, or manipulating items in various environments. In order to carry out such tasks, a robot needs to determine how to position and orient a robot gripper or an end-effector to securely grasp a given object, which is referred to as generating a grasp pose. A grasp pose includes both the location and orientation of the end-effector (e.g., gripper) of the robot relative to the object and can permit the object to be lifted, moved, or used without slipping or falling. Accurate grasp pose generation is important in a wide range of applications, such as warehouse automation, manufacturing, home robotics, medical robotics, and/or the like. For grasp pose generation, the robot often processes sensor data, such as depth or vision information, to assess the object geometry, and then computes one or more grasp poses that are physically feasible and appropriate for a task the robot will perform.

Conventional approaches for grasp pose generation use various algorithmic and learning-based approaches to identify feasible grasp poses. Conventional approaches for grasp pose generation include geometric heuristics that analyze object shape, edges, curvature, and surface normals to generate stable contact points that satisfy basic grasp pose stability criteria. Sampling-based approaches for grasp pose generation generate large sets of candidate grasp poses and evaluate the candidate grasp poses using analytic techniques, such as force closure, wrench resistance, grasp isotropy, and/or the like. Deep learning models have also been developed to generate grasp poses directly from visual or depth input, often using convolutional neural networks or point cloud encoders trained on large-scale grasp datasets. Other conventional approaches include knowledge-based reasoning to generate grasp poses for unstructured or cluttered environments. Still other conventional approaches include reinforcement learning or simulation-to-real transfer that iteratively refine grasp pose generation policies through interaction with an object.

One drawback of conventional approaches for grasp pose generation is that these approaches require assumptions or processing steps that limit scalability and generalization in real-world environments. For example, conventional approaches involving deep learning models are trained under the assumption that the geometry of an object to be grasped is readily available, which limits the effectiveness of such approaches in cluttered or occluded scenes where the object geometry may not always be available. Sampling-based approaches for grasp pose generation also require multi-view scans of the object to accurately evaluate candidate grasp poses, making these approaches impractical for real-time deployment in dynamic environments where multi-view scans are difficult to obtain. In addition, geometric heuristics and contact point-based approaches, while effective for simple scenarios, often do not generalize well to different types of grippers and are typically optimized for only parallel-jaw grippers. Furthermore, knowledge-based and simulation-driven approaches for grasp pose generation that are designed for multi-object scenes often rely on full-scene simulation or instance segmentation to isolate the object being grasped before generating grasp poses, which can be computationally expensive and difficult to scale beyond tabletop setups.

As the foregoing illustrates, what is needed in the art are more effective techniques for robot grasp pose generation.

### SUMMARY

According to some embodiments, a computer-implemented method for controlling a robot to grasp an object includes receiving sensor data from one or more sensors. The method further includes generating, based on the sensor data and using a first trained machine learning model, one or more grasp poses. The method additionally includes selecting, from the one or more grasp poses and using a first trained machine learning model, one or more filtered grasp poses. Furthermore, the method includes generating, based on the one or more filtered grasp poses, a grasping plan. The method also includes causing the robot to grasp the object based on the grasping plan.

Further embodiments provide, among other things, non-transitory computer-readable storage media storing instructions and systems configured to implement the method set forth above.

At least one technical advantage of the disclosed techniques relative to the prior art is that the disclosed techniques permit scalable, general-purpose grasp pose generation in diverse environments without requiring strong assumptions about object geometry, gripper type, or scene composition. The disclosed techniques use a grasp diffusion model conditioned on object geometry derived from single-view point clouds, which removes the need for multi-view scans or complete 3D mesh reconstructions and allows grasp poses to be generated in cluttered or partially occluded environments. In addition, the disclosed techniques generalize across various gripper modalities, including suction-based, articulated grippers, and/or the like. Furthermore, the disclosed techniques eliminate reliance on full-scene simulation or instance segmentation during runtime by focusing on object-centric modeling, permitting more efficient and modular deployment in real-world robotic systems. The disclosed techniques use a grasp discriminator model to filter out low-likelihood or collision-prone grasp poses, improving grasp reliability without requiring manually defined heuristics. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A illustrates how the model trainer of FIG. 1 trains a grasp diffusion model, according to various embodiments;

FIG. 3B illustrates how the grasp generation module and the simulator of FIG. 1 generate augmented grasp data, according to various embodiments;

FIG. 3C illustrates how the model trainer of FIG. 1 trains a grasp discriminator model, according to various embodiments;

FIG. 4 is a more detailed illustration of the robot control application of FIG. 1, according to various embodiments;

FIG. 5 is a more detailed illustration of the grasp diffusion model of FIG. 1, according to various embodiments;

FIG. 6 is a flow diagram of method steps for training a grasp diffusion model and a grasp discriminator model, according to various embodiments;

FIG. 7 is a flow diagram of method steps for training a grasp diffusion model, according to various embodiments;

FIG. 8 is a flow diagram of method steps for generating the augmented grasp data, according to various embodiments;

FIG. 9 is a flow diagram of method steps for training a grasp discriminator model, according to various embodiments;

FIG. 10 is a flow diagram of method steps for controlling a robot, according to various embodiments; and

FIG. 11 is a flow diagram of method steps for generating grasp poses, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for . . .

The grasp pose generation techniques of the present disclosure have many real-world applications. For example, the grasp pose generation techniques can be used to enable robotic manipulation in warehouse automation, including bin picking, order fulfillment, and object sorting. As another example, the grasp pose generation techniques can be applied in industrial automation settings to support tasks, such as assembly, packaging, and material handling. In the field of domestic robotics, the grasp pose generation techniques can be used to assist with tasks such as picking up household items, organizing objects, or assisting individuals with limited mobility. The grasp pose generation techniques may also be used in surgical robotics, agricultural robotics, or research platforms requiring reliable interaction with a variety of physical objects.

The above examples are not in any way intended to be limiting. As persons skilled in the art will appreciate, as a general matter, the grasp pose generation techniques described herein can be implemented in any suitable application.

### System Overview

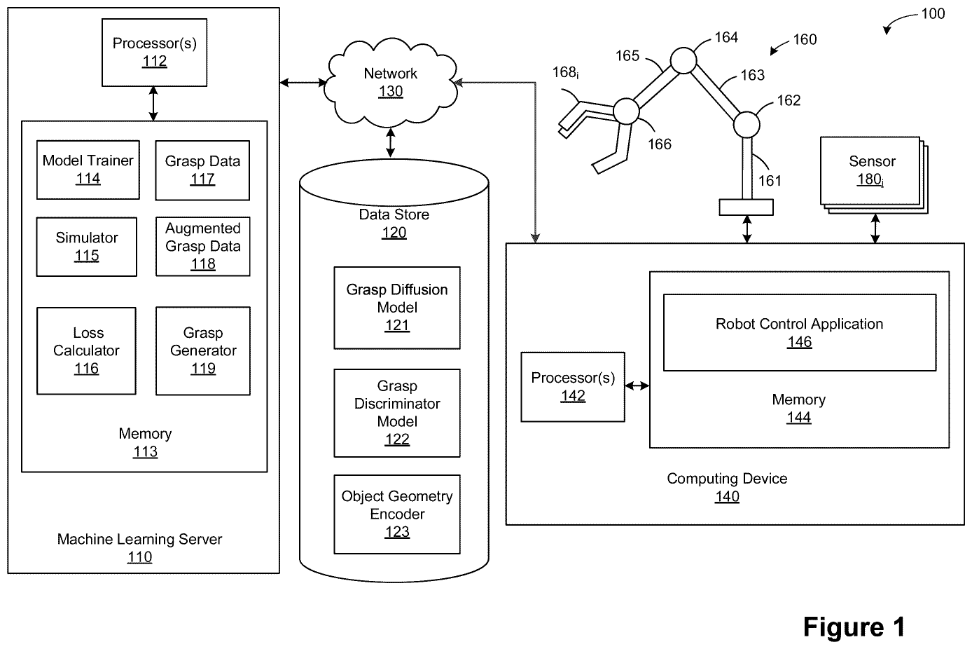

FIG. 1 is a block diagram of a computer system 100 configured to implement one or more aspects of various embodiments. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 113 includes, without limitation, a model trainer 114, a simulator 115, a loss calculator 116, grasp data 117, augmented grasp data 118, and grasp generator 119. Data store 120 includes, without limitation, a grasp diffusion model 121, a grasp discriminator model 122, and an object geometry encoder 123. Computing device 140 includes, without limitation, processor(s) 142 and memory 144. Memory 144 includes, without limitation, a robot control application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 113 of machine learning server 110 stores content, such as software applications and data, for use by processor(s) 112 and the GPU(s) and/or other processing units. System memory 113 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 113 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

As shown, grasp generator 119 executes on one or more processors 112 of machine learning server 110 and is stored in system memory 113 of machine learning server 110. In various embodiments, grasp generator 119 is an application or other software that uses a trained machine learning model, such as grasp diffusion model 121, to process an object geometry embedding and generate a predicted grasp pose. In some embodiments, the object geometry embedding is generated by processing object geometry data included in grasp data 117 by a machine learning model, such as object geometry encoder 123, that processes the object geometry data and generates an object geometry embedding. Grasp data 117 can be stored in datastore 120 or elsewhere (e.g., memory 113). Grasp data 117 includes, without limitation, the object geometry data and grasp pose data. The object geometry data includes a three-dimensional (3D) shape of an object, such as a point cloud, polygon mesh, or other geometric representation derived from sensor inputs or simulation. The grasp pose data includes one or more six-degree-of-freedom (6-DOF) gripper transformations, each specifying a position and orientation of a robotic end-effector (e.g., gripper), such as end-effector 166 of robot 160, relative to the object. In some embodiments, each grasp pose included in the grasp pose data is associated with a binary grasp pose label indicating grasp success or failure.

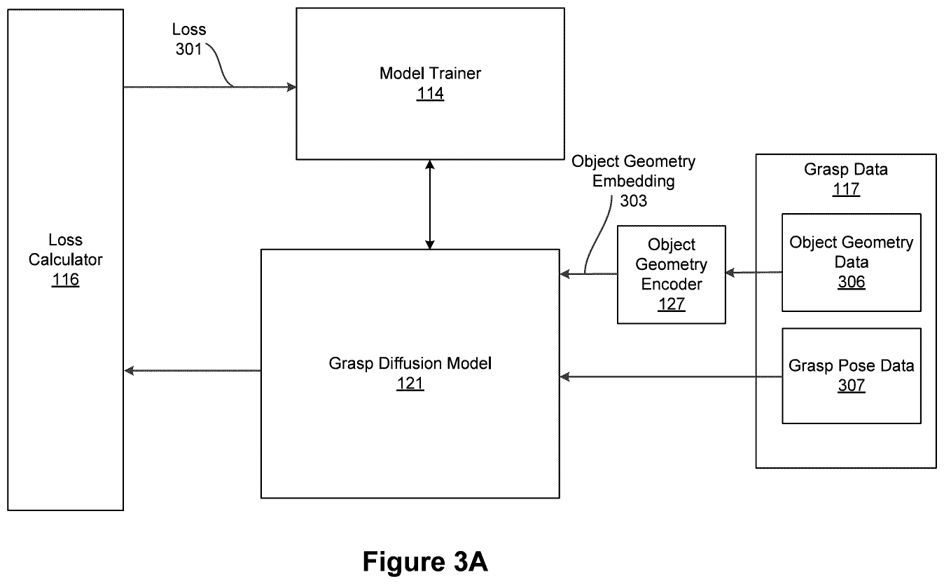

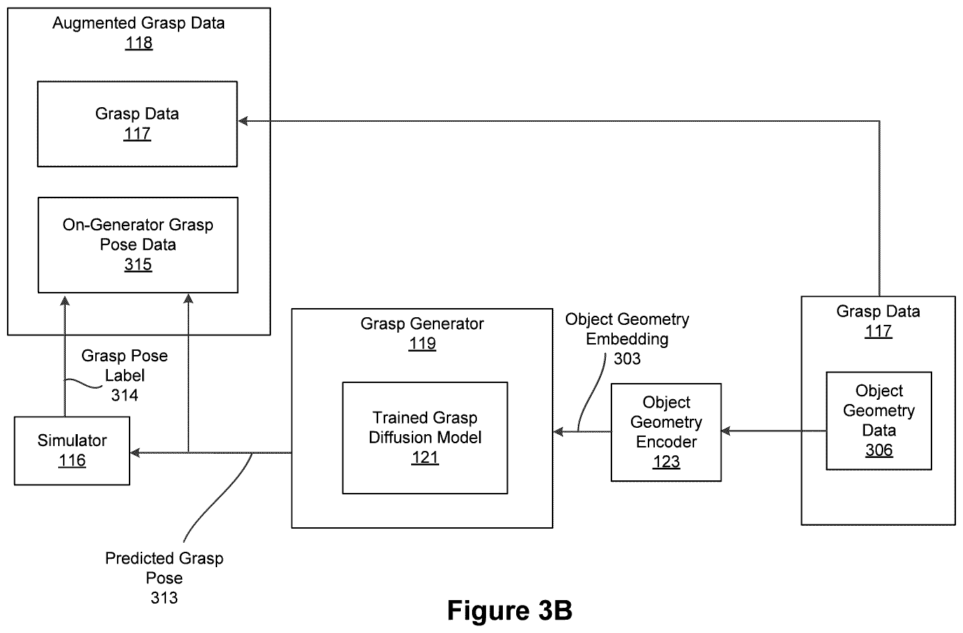

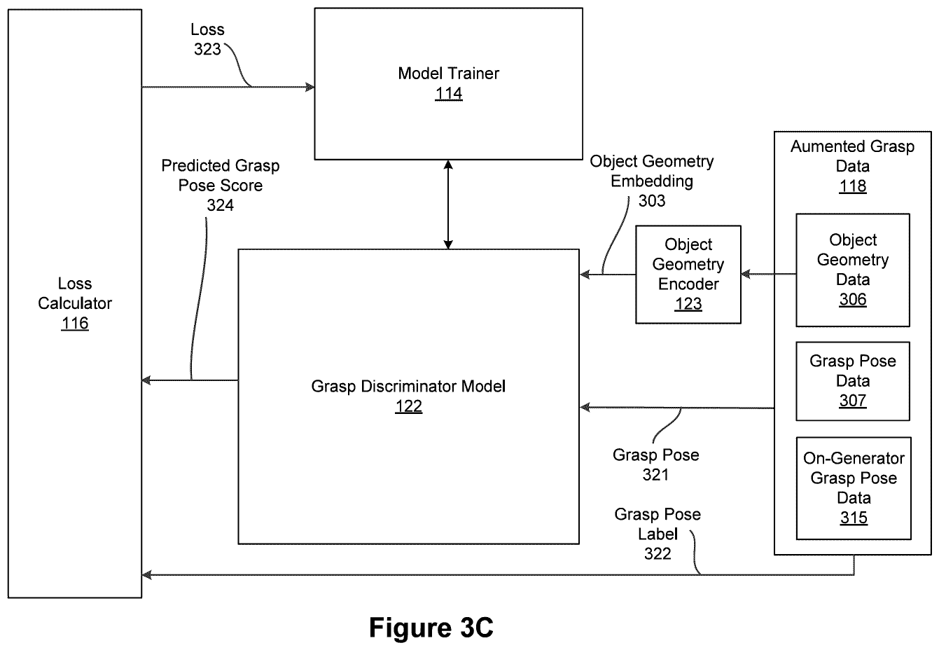

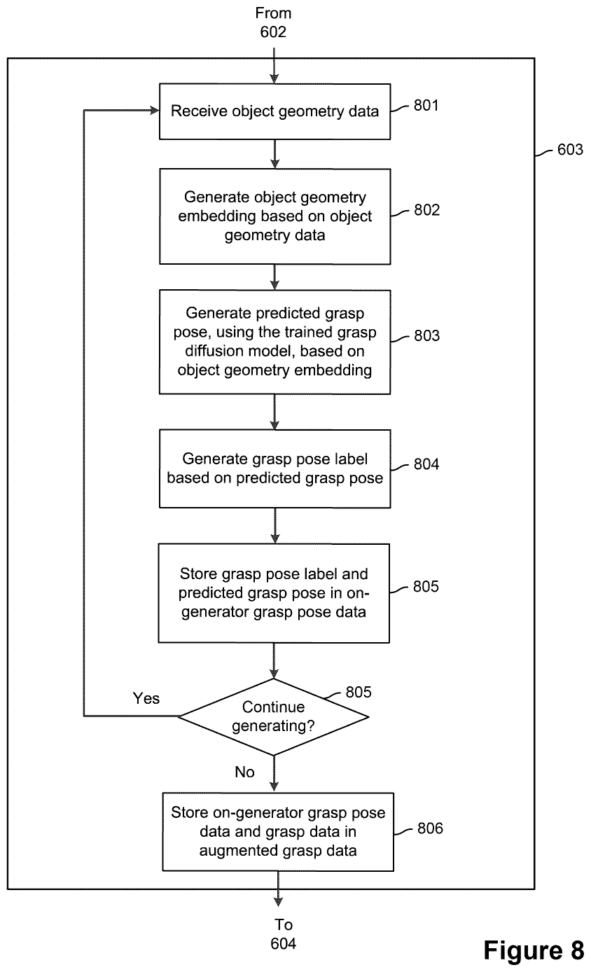

As shown, simulator 115 executes on one or more processors 112 of machine learning server 110 and is stored in system memory 113 of machine learning server 110. In various embodiments, simulator 115 is an application that uses a predicted grasp pose to simulate robot 160 performing the predicted grasp pose and generates a grasp pose label, such as successful grasp pose or unsuccessful grasp pose. In some embodiments, the predicted grasp pose and the grasp pose label are stored in augmented grasp data 118, which can be stored in data store 120 or elsewhere (e.g., in memory 113). Techniques for generating augmented grasp data 118 are described in greater detail in conjunction with FIGS. 3B and 8.

As shown, loss calculator 116 executes on one or more processors 112 of machine learning server 110 and is stored in system memory 113 of machine learning server 110. In various embodiments, loss calculator 116 is an application or other software that (1) calculates a first loss based on the predicted noise generated by grasp diffusion model 121 and an added noise and (2) calculates a second loss based on the predicted grasp pose label generated by simulator 115 and a corresponding grasp pose label included in augmented grasp data 118.

As shown, model trainer 114 is an application that executes on one or more processors 112 of machine learning server 110 and is stored in a system memory 113 of machine learning server 110. Although shown as distinct from simulator 115, loss calculator 116, and grasp generator 119 for illustrative purposes, in some embodiments, functionality of simulator 115, loss calculator 116, and/or grasp generator 119 can be combined into a single application or separated into any number of applications.

In some embodiments, model trainer 114 is configured to train one or more machine learning models, including grasp diffusion model 121 and grasp discriminator model 122. Grasp diffusion model 121 is a machine learning model, such as a neural network, which is trained to generate a predicted noise based on a time step, an object geometry embedding, and a noisy grasp pose. Grasp discriminator model 122 is another machine learning model, such as a neural network, which processes a grasp pose and generates a predicted grasp pose score. Techniques for training grasp diffusion model 121 based on grasp data 117 and training grasp discriminator model 122 based on augmented grasp data 118 are discussed in greater detail herein in conjunction with at least FIGS. 3A, 3C, 6-7, and 9. Grasp diffusion model 121 and grasp discriminator model 122 can be stored in data store 120. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

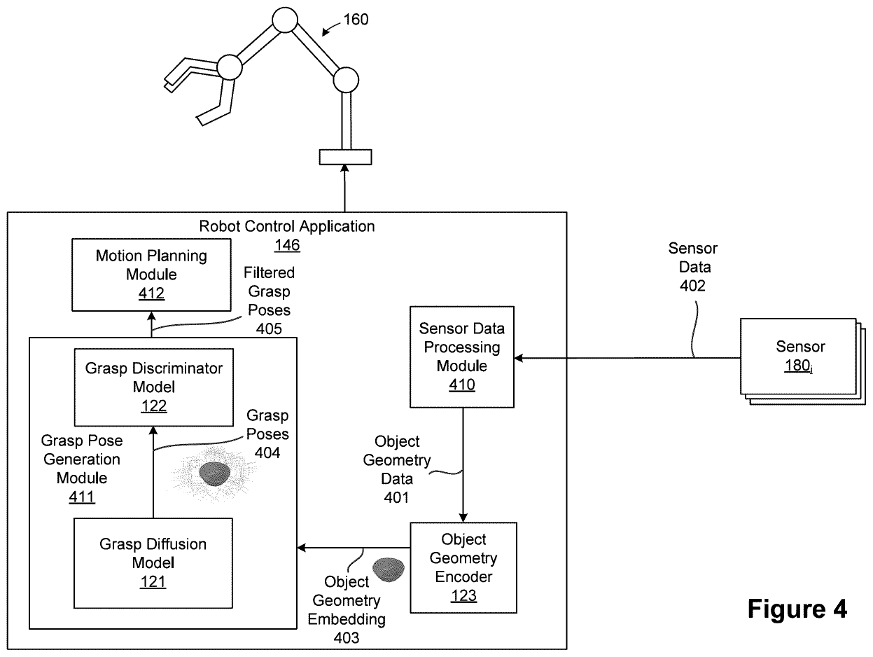

As shown, a robot control application 146, which can use grasp diffusion model 121 and grasp discriminator model 122, is stored in memory 144 and executes on processor(s) 142 of computing device 140. Once trained, grasp diffusion model 121 and grasp discriminator model 122 can be deployed, such as via robot control application 146, to control a physical robot in a real-world environment, such as robot 160. In various embodiments, trained grasp diffusion model 121 and grasp discriminator model 122 are deployed for use with virtual environments, such as in a simulator (e.g., simulator 115) where a virtual model of robot 160 is simulated within a virtual environment, such as a digital twin or a simulation platform. In the virtual deployment, robot control application 146 interfaces with a virtual representation of robot 160, which can enable testing, validation, and refinement of robot plans. Robot control application 146 processes sensor data acquired via one or more sensors 180; (referred to herein collectively as sensors 180 and individually as a sensor 180), and generates one or more controls for robot 160, as discussed in greater detail below in conjunction with FIGS. 4, 10, and 11. For example, in at least one embodiment, sensors 180 can include one or more cameras, one or more red-green-blue-depth (RGB-D) cameras (e.g., cameras using time-of-flight sensors), such as a wrist-mounted RGB-D camera, one or more Light Detection and Ranging (LiDAR) sensors, any combination thereof, etc. Memory 144 and the processor(s) 142 can be similar to memory 113 and processor(s) 112 of machine learning server 110, described above.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168; (referred to herein collectively as fingers 168 and individually as a finger 168) that form a gripper and can be controlled to grasp an object. For example, in at least one embodiment, robot 160 can include a locked wrist and multiple (e.g., four) fingers. Although an example robot 160 is shown for illustrative purposes, in at least one embodiment, techniques disclosed herein can be applied to control any suitable robot.

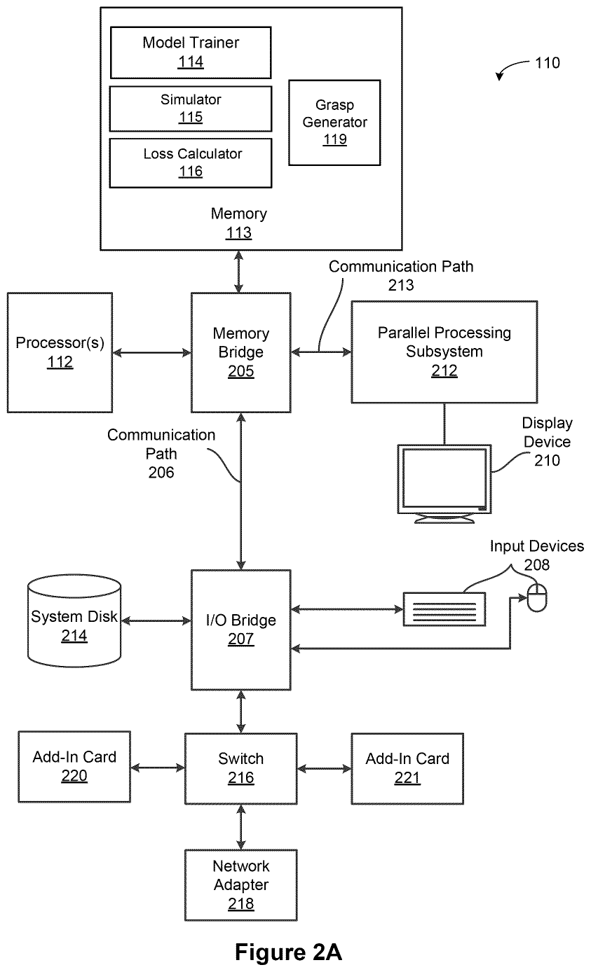

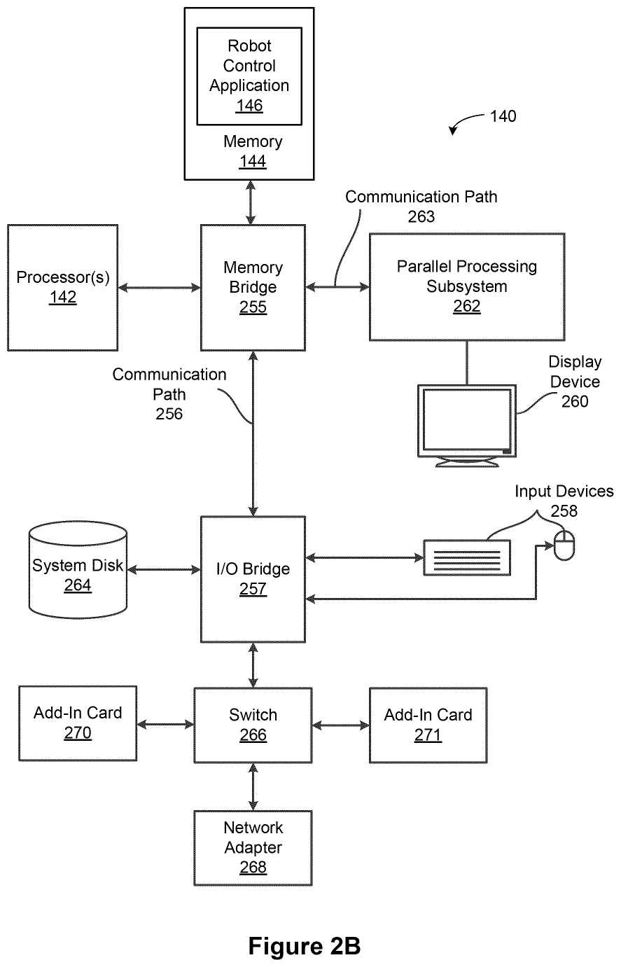

FIG. 2A is a more detailed illustration of machine learning server 110 of FIG. 1, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 113 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 113 includes at least one device driver configured to manage the processing operations of the one or more PPUs within parallel processing subsystem 212. In addition, system memory 113 includes, without limitation, model trainer 114, simulator 115, loss calculator 116, and grasp generator 119. Although described herein primarily with respect to model trainer 114, simulator 115, loss calculator 116, and grasp generator 119, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, may be modified as desired. For example, in some embodiments, system memory 113 could be connected to the processor(s) 112 directly rather than through memory bridge 205, and other devices may communicate with system memory 113 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a more detailed illustration of computing device 140 of FIG. 1, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes robot control application 146. Although described herein primarily with respect to robot control application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Grasp Diffusion Model Using Grasp Data

FIG. 3A illustrates how model trainer 114 trains grasp diffusion model 121, according to various embodiments. As shown, grasp data 117 includes, without limitation, object geometry data 306 and grasp pose data 307. In operation, object geometry encoder 123 processes object geometry data 306 and generates object geometry embedding 303. Model trainer 114 uses grasp diffusion model 121 to process object geometry embedding 303 and performs forward diffusion steps to generate a predicted noise. During the forward diffusion steps, model trainer 114 adds noise to a grasp pose included in the grasp pose data 307 and generates a noisy grasp pose at each forward diffusion time step. In some embodiments, grasp diffusion model 121 processes the noisy grasp pose, the time step, and object geometry embedding 303 and generates a predicted noise. Loss calculator 116 compares the predicted noise with the added noise and calculates loss 301. Model trainer 114 uses loss 301 to iteratively update parameters of grasp diffusion model 121 until one or more stopping criteria are met.

Grasp data 117 includes object geometry data 306 and grasp pose data 307. Object geometry data 306 [symbol] includes the 3D shape of one or more objects, such as a point cloud, polygon mesh, or other geometric representation derived from a sensor input or simulation. Grasp pose data 307 includes one or more 6-DOF gripper transformations, each specifying a position and orientation of a robotic end-effector relative to an object. In some embodiments, each grasp pose included in grasp pose data 307 is accompanied with a grasp pose label, indicating grasp success or failure. Let [symbol] ⁺ denotes the set of successful grasp poses, and [symbol] ⁻ denotes the set of unsuccessful grasp poses. Then, grasp pose data 307 can be denoted by { [symbol] ⁺, [symbol] ⁻} and grasp data 117 can be denoted by [symbol] ={ [symbol] , [symbol] ⁺, [symbol] ⁻}. In some embodiments, the grasp pose label includes a success rate, such as a value between zero and one, rather than a binary label. In at least one example, the grasp pose label is determined through a simulated shaking procedure following the Annotated Clutter Removal and Object Grasping with Neural Metrics (ACRONYM) pipeline. For example, in some embodiments, grasp pose data 307 can be generated by sampling a fixed number (e.g., 2,000) grasp poses uniformly around a given 3D object mesh and evaluating each grasp pose in simulation using a simulator, such as the Isaac® physics simulator. In such cases, a grasp pose is labeled as successful when a stable contact configuration remains after the object is shaken within the gripper. In some embodiments, the object meshes included in object geometry data 306 can be selected from a publicly available collection of 3D object geometry dataset, such as the Objaverse dataset. In some embodiments, grasp pose data 307 includes grasp poses for various types of antipodal grippers, such as the Franka Emika Panda gripper and the Robotiq-2F-140 parallel-jaw gripper. In some embodiments, grasp pose data 307 includes grasp poses for a suction-based gripper, such as a 30 mm vacuum gripper. In some embodiments, for a suction gripper, grasp success labels included in the grasp pose labels are computed using an analytical contact model.

Object geometry encoder 123 is a machine learning model, such as a neural network, which processes object geometry data 306 and generates object geometry embedding 303. In some embodiments, object geometry encoder 123 includes a transformer-based architecture trained to extract geometric features from unstructured point cloud data included in object geometry data 306. For example, object geometry encoder 123 could include a PointTransformerV3 (PTv3) model, which first serializes the unstructured point cloud included in object geometry data 306 into a structured sequence (e.g., a serialized representation) and then applies a transformer to process the serialized representation. Object geometry embedding 303 includes a latent representation that captures the spatial and structural characteristics of the object geometry included in object geometry data 306. In some embodiments, object geometry encoder 123 is trained jointly with grasp diffusion model 121. In some embodiments, object geometry encoder 123 is pre-trained and reused in a frozen state during inference or when training grasp diffusion model 121.

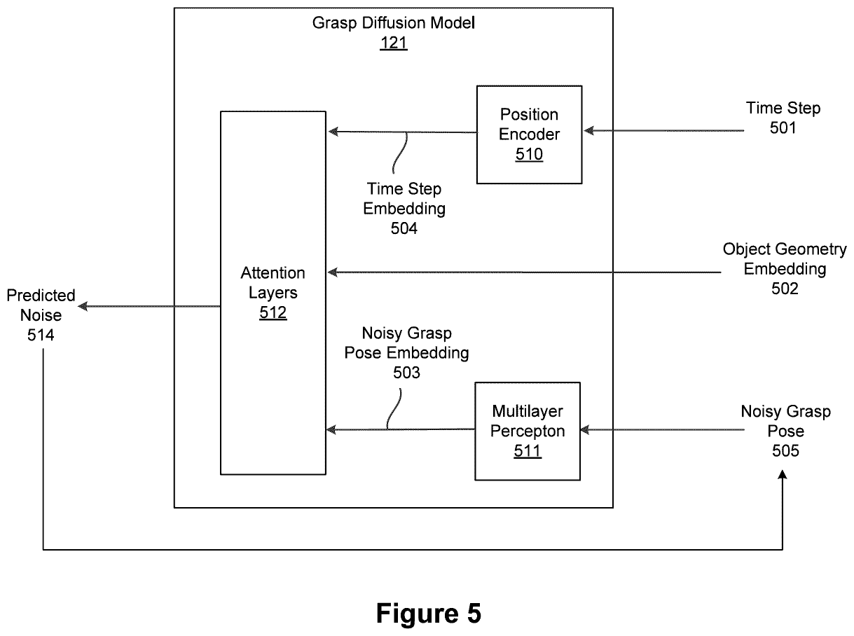

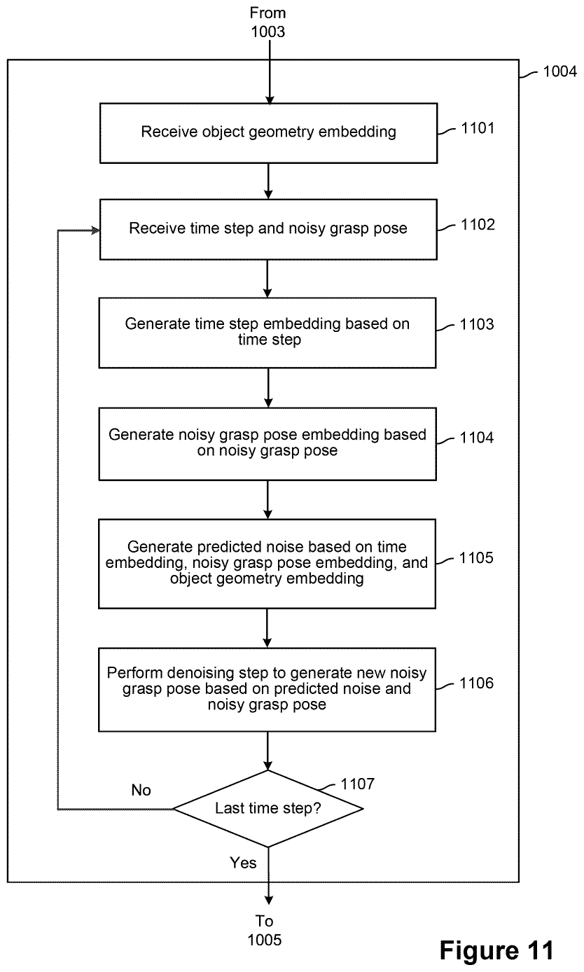

Grasp diffusion model 121 is a machine learning model, such as a neural network, which processes object geometry embedding 303, a timestep, and a noisy grasp pose and generates a predicted noise. In some embodiments, grasp diffusion model 121 includes a denoising diffusion probabilistic model (DDPM), and the DDPM can be trained to generate 6-DOF grasp poses through an iterative reverse diffusion process. In some embodiments, grasp diffusion model 121 receives as input a noisy grasp pose gₜ∈SE(3), a scalar timestep t, and object geometry embedding 303 encoding the 3D structure of the target object. Grasp diffusion model 121 predicts the noise component \grave{∈} corresponding to t, which is then used to compute a denoised grasp pose gₜ₋₁ for the previous timestep. The reverse diffusion process is repeated until a clean grasp pose g₀ is obtained. In some embodiments, grasp poses gₜ lies in the Lie group SE(3), which represents rigid body transformations composed of rotation and translation. In some embodiments, to simplify training and enable operation in Euclidean space, grasp diffusion model 121 factorizes SE(3) into SO(3)× [symbol] ³, where SO(3) captures the rotation matrix and [symbol] ³ captures the translation vector. For rotation, grasp diffusion model 121 obtains bounded representations using exponential mapping, ensuring values lie within [−π,π]. For translation, grasp diffusion model 121 applies normalization to bring object-dependent translation scales into a consistent range. In some embodiments, grasp diffusion model 121 uses a normalization constant κ to bring object-dependent translation scales into a consistent range, which can be computed as follows:

$$κ = {( \frac{1}{N} {\sum }_{i = 0}^{N} ( max ( {t}_{i} ) - min ( {t}_{i} ) ) )}^{- 1} , \qquad ( Equation 1 )$$

where tᵢ∈ [symbol] ³ is the translation component of each grasp pose for object i, and N is the number of objects. The translation vector for each grasp pose is scaled by κ to permit numerical stability and consistency across objects of varying sizes. In some embodiments, during inference, grasp diffusion model 121 begins from a noisy grasp sample g_{T}, for example, drawn from a standard normal distribution in the SE(3) latent space [symbol] (0,I). In some embodiments, grasp diffusion model 121 iteratively predicts noise and applies the DDPM reverse update rule:

$${g}_{t - 1} = \frac{1}{\sqrt{{α}_{t}}} ( {g}_{t} - \frac{1 - {α}_{t}}{\sqrt{1 - {{α}^{↼}}_{t}}} \cdot {ϵ}^{‵} ) + {σ}_{t} \cdot z , \qquad ( Equation 2 )$$

where αₜ and [symbol] are predefined schedule parameters, \grave{∈} is the predicted noise, σₜ is a noise scale factor, and z˜ [symbol] (0,I) is a Gaussian added noise. In some embodiments, the reverse diffusion process is applied for a fixed number of steps (e.g., T=10) until a clean grasp pose g₀ is generated. In some embodiments, the point clouds included in object geometry embedding 502, as well as the noisy grasp poses, are transformed to the point cloud mean center before passing through grasp diffusion model 121. In some embodiments, grasp diffusion model 121 includes a position encoder, a multi-layer perceptron, and one or more attention layers. Grasp diffusion model 121 is described in more detail in conjunction with FIGS. 5 and 11.

In some embodiments, model trainer 114 uses grasp diffusion model 121 to process object geometry embedding 303 and grasp pose data 307 and performs forward diffusion steps to generate a predicted noise. During the forward diffusion steps, model trainer 114 adds noise to a grasp pose included in the grasp pose data 307 and generates a noisy grasp pose at each forward diffusion time step. In some embodiments, the forward diffusion process begins with a clean grasp pose g₀∈ [symbol] ⁺, where [symbol] ⁺ is the set of grasp poses labeled as successful included in grasp pose data 307. Model trainer 114 samples a diffusion timestep t∈{1, . . . , T} and adds Gaussian noise to the clean pose g₀ to generate a noisy grasp pose gₜ, according to a predefined noise schedule, such as a cosine schedule. In some embodiments, the forward diffusion process can follow the DDPM formulation:

$${ℊ}_{t} = \sqrt{{{α}^{↼}}_{t}} \cdot {ℊ}_{0} + \sqrt{1 - {{α}^{↼}}_{t}} \cdot ϵ , \qquad ( Equation 3 )$$

where ∈˜ [symbol] (0,I) is Gaussian noise. Grasp diffusion model 121 then processes the resulting noisy grasp pose gₜ, the timestep t and object geometry embedding 303 and generates predicted noise è. In some embodiments, grasp diffusion model 121 can be represented by a parametric function described as

$${ϵ}^{‵} = ϕ ( t , {g}_{t} , X ) , \qquad ( Equation 4 )$$

where X denotes object geometry embedding 303.

Loss calculator 116 compares the predicted noise and the added noise and calculates loss 301. In some embodiments, loss calculator 116 calculates a denoising loss that quantifies the difference between the predicted noise and the added noise using a squared L2 norm. In some embodiments, the denoising loss is defined as:

$$ℒ = {‖ ϵ - {ϵ}^{‵} ‖}_{2}^{2} , \qquad ( Equation 5 )$$

In some embodiments, loss calculator 116 separately applies the L2 loss to the rotation and translation components of the grasp pose.

Model trainer 114 uses loss 301 to iteratively update the parameters of grasp diffusion model 121. In some embodiments, model trainer 114 performs gradient-based optimization, such as stochastic gradient descent (SGD), adaptive moment estimation (Adam), or another adaptive optimizer to minimize loss 301 across batches of training samples from grasp data 117. In some embodiments, training is performed over a fixed number of epochs or iterations. In some embodiments, model trainer 114 applies dynamic stopping criteria based on model performance on a held-out validation set. For example, training can stop once a validation loss falls below a predetermined threshold or when improvements in validation loss fall below a defined tolerance over a specified number of epochs (e.g., early stopping). In some embodiments, model trainer 114 includes stopping criteria based on convergence behavior, such as when the moving average of the training loss 301 stabilizes, or when gradients fall below a minimum magnitude, indicating that additional updates are unlikely to improve performance. Once training of grasp diffusion model 121 is completed, model trainer 114 stores the trained grasp diffusion model 121 in datastore 120 or elsewhere.

### Generating Augmented Grasp Data Using Object Geometry Data and Trained Grasp Diffusion Model

FIG. 3B illustrates how grasp generator 119 and simulator 116 generate augmented grasp data 118, according to various embodiments. As shown, grasp data 117 includes, without limitation, object geometry data 306. Augmented grasp data 118 includes, without limitation, grasp data 117 and on-generator grasp data 315. Grasp generator 119 includes, without limitation, trained grasp diffusion model 121. In operation, object geometry encoder 123 processes object geometry data 306 and generates object geometry embedding 303. Grasp generator 119 uses trained grasp diffusion model 121 to process object geometry embedding 303 and generate predicted grasp pose 313. Simulator 116 simulates predicted grasp pose 313 and generates corresponding grasp pose label 314. Grasp generator 119 then stores predicted grasp pose 313 and grasp pose label 314 in on-generator grasp pose data 315.

Object geometry encoder 123 processes object geometry data 306 and generates object geometry embedding 303. As described, in some embodiments, Object geometry encoder 123 includes a transformer-based architecture trained to extract geometric features from unstructured point cloud data included in object geometry data 306. For example, object geometry encoder 123 could include a PTv3 model, which first serializes the unstructured point cloud into a structured sequence (e.g., a serialized representation) and then applies a transformer to process the serialized representation.

Grasp generator 119 is an application that uses trained grasp diffusion model 121 to process object geometry embedding 303 and generate predicted grasp pose 313. In some embodiments, grasp generator 119 performs a reverse diffusion process to process object geometry embedding 303 and generate predicted grasp pose 313. In some embodiments, the reverse diffusion process begins by sampling an initial noisy grasp pose g_{T}˜ [symbol] (0,I) from a standard multivariate Gaussian distribution in the latent SE(3) space. Grasp generator 119 then uses the trained grasp diffusion model 121 to iteratively denoise the noisy grasp pose g_{T} for a fixed number of reverse diffusion steps (e.g., T=10) and generate a clean grasp pose g₀ (e.g., predicted grasp pose 313). At each timestep t∈{T, T−1, . . . , 1}, grasp generator 119 inputs the noisy grasp pose gₜ, the timestep t, and the object geometry embedding 303 into the trained grasp diffusion model 121, which generates the predicted noise, such as using Equation 4. In some embodiments, the predicted noise is then used to compute the next denoised sample gₜ₋₁ using the DDPM reverse update rule as described in Equation 2. The denoising process is repeated until the clean grasp pose g₀ is obtained. In some embodiments, grasp generator 119 operates on grasp poses that are factorized into separate translation and rotation components in [symbol] ³ and SO(3), respectively, and grasp diffusion model 119 is configured to denoise the translation and rotation components separately by running two separate denoising processes-one for translation and one for rotation—each with a dedicated noise schedule. In some embodiments, predicted grasp pose 313 can be represented as a 4×4 homogeneous transformation matrix, which combines the predicted translation and rotation into a single SE(3) pose that can be executed by a robotic end-effector in physical space.

Simulator 116 is an application that simulates predicted grasp pose 313 and generates grasp pose label 314. In some embodiments, simulator 116 applies predicted grasp pose 313 to a virtual robotic end-effector within a simulated environment and evaluates whether predicted grasp pose 313 is successful based on simulated physical interaction with a target object. In some embodiments, simulator 116 checks whether the virtual robotic end-effector can perform predicted grasp pose 313 without collisions. In some embodiments, simulator 116 includes dynamic physics modeling, including but not limited to gravity, collisions, and frictional contact between the gripper and the object. For example, simulator 116 could simulate the gripper approaching the object, closing around the object, and executing a shaking motion to assess grasp stability such that a predicted grasp pose 313 is labeled as successful whenever the object remains securely held after the shaking procedure is completed. In some embodiments, simulator 116 includes a labeling protocol used in simulation-based benchmarks, such as ACRONYM or similar grasping frameworks. In some embodiments, grasp pose label 314 is a binary label (e.g., success or failure). In some embodiments, grasp pose label 314 includes a continuous-valued score reflecting grasp stability, contact force margins, or other physical metrics. In some embodiments, simulator 116 is configured to evaluate predicted grasp poses 313 for different gripper types, such as parallel-jaw grippers, suction-based grippers, and/or the like, using either physics-based or analytical models depending on the gripper modality. In some embodiments, grasp generator 119 continues to generate predicted grasp poses 313 until a pre-defined number of predicted grasp poses 313 are generated. In some embodiments, grasp generator 119 continues to generate predicted grasp poses 313 for a fixed number of object geometries included in object geometry data 306.

In some embodiments, grasp generator 119 stores predicted grasp pose 313 and grasp pose label 313 in on-generator grasp pose data 315. Augmented grasp data 118 includes on-generator grasp pose data 315 and grasp data 117. In some embodiments, augmented grasp data 118 includes the union of grasp data 117 [symbol] and on-generator grasp data 315 [symbol] ⁺∪ [symbol] ⁻, where [symbol] ⁺ denotes the set of predicted grasp poses 313 with successful grasp pose label 314 and [symbol] ⁻ denotes the set of predicted grasp poses 313 with unsuccessful grasp pose label 314. In some other embodiments, only on-generator grasp data may be used, and augmented grasp data 118 can include only the on-generator grasp data.

### Training Grasp Discriminator Model Using Trained Grasp Diffusion Model and Augmented Grasp Data

FIG. 3C illustrates how model trainer 114 trains grasp discriminator model 122, according to various embodiments. As shown, augmented grasp data 118 includes object geometry data 306, grasp pose data 307, and on-generator grasp pose data 315. In operation, object geometry encoder 123 processes object geometry data 306 and generates object geometry embedding 303. Grasp discriminator model 122 processes object geometry embedding 303 and grasp pose 321 included in grasp pose data 307 and on-generator grasp pose data 315 and generates predicted grasp pose score 324. Loss calculator 116 compares predicted grasp pose score 324 and grasp pose label 322 included in grasp pose data 307 and on-generator grasp pose data 315 and calculates loss 323. Model trainer 114 uses loss 323 to iteratively update parameters of grasp discriminator model 122 until one or more stopping criteria are met.

Object geometry encoder 123 is a machine learning model, such as a neural network, which processes object geometry data 306 and generates object geometry embedding 303. As described, in some embodiments, object geometry encoder 123 includes a transformer-based architecture trained to extract geometric features from unstructured point cloud data included in object geometry data 306. For example, object geometry encoder 123 could include a PTv3 model, which first serializes the unstructured point cloud into a structured sequence (e.g., a serialized representation) and then applies a transformer to process the serialized representation.

Grasp discriminator model 122 is a machine learning model, such as a neural network, which processes object geometry embedding 303 and grasp pose 321 and generates predicted grasp pose score 324. In some embodiments, grasp discriminator model 122 includes a binary classifier that predicts whether a given grasp pose 321 is likely to be successful or unsuccessful, conditioned on the geometry of the target object included in object geometry embedding 303. In some embodiments, grasp discriminator model 122 includes a multilayer perceptron, a transformer-based architecture, and/or the like. In some embodiments, predicted grasp pose score 324 is a continuous-valued score between 0 and 1 that represents confidence that grasp pose 321 will result in a stable and successful grasp. In some implementations, predicted grasp pose score 324 includes a grasp success probability, where values closer to 1 indicate higher confidence of success and values closer to 0 indicate higher likelihood of failure. In some embodiments, grasp discriminator model 122 uses a fixed threshold to generate predicted grasp pose score 324 as a binary grasp success/failure prediction.

Loss calculator 116 compares predicted grasp pose score 324 with grasp pose label 322 and calculates loss 323. In some embodiments, loss calculator 116 calculates a binary classification loss, such as binary cross-entropy, which measures the divergence between a predicted grasp success score (e.g., predicted grasp pose score 324) \grave{y}∈[0,1] generated by grasp discriminator model 122 and the ground-truth label (e.g., grasp pose label 322) y∈{0,1}. In some embodiments, loss 323 is defined as:

$${ℒ}_{BCE} = - [ y \cdot log ( {y}^{‵} ) + ( 1 - y ) \cdot log ( 1 - {y}^{‵} ) ] , \qquad ( Equation 6 )$$

which penalizes confident incorrect predicted grasp pose scores 324 more heavily and encourages grasp discriminator model 122 to generate output scores (e.g., predicted grasp pose scores 324) that align with the observed labels (e.g., grasp pose label 322). In some embodiments, loss calculator 116 calculates loss 323 over a batch of predicted grasp pose scores 324 and returns the average loss across the batch.

Model trainer 114 uses loss 323 to update parameters of grasp discriminator model 122. In some embodiments, model trainer 114 uses batches of augmented grasp data 118 with an equal split between grasp pose data 307 and on-generator grasp pose data 315, and with a balanced distribution of successful and unsuccessful grasp pose labels 322. In some embodiments, model trainer 114 minimizes loss 323 using a gradient-based optimization algorithm, such as SGD, Adam, and/or the like. In some embodiments, model trainer 114 updates the parameters of grasp discriminator model 122 for a fixed number of epochs or until a stopping criterion is met. In some embodiments, the stopping criteria include convergence of the training loss 323, stabilization of a validation loss, or failure to improve validation performance beyond a defined threshold over a specified number of epochs (e.g., early stopping). In some embodiments, model trainer 114 monitors gradient norms and training terminates when gradients fall below a minimum threshold, indicating diminishing returns from further updates. Once grasp discriminator model 122 is trained, model trainer 114 stores the trained grasp discriminator model 122 in datastore 120 or elsewhere.

In some embodiments, model trainer 114 trains grasp generation model 121 and grasp discriminator model 122 and grasp generator 119 generates augmented grasp data 118 as described by Algorithm 1.

Algorithm 1: GraspGen Training Recipe

Input: Object dataset [symbol] , Grasp dataset [symbol] ⁺ ∪ [symbol] ⁻.
Step 1: Initialize the aggregated dataset [symbol] ← { [symbol] , [symbol] ⁺, [symbol] ⁻}.
$Step 2 : Train the grasp diffusion model ( generator ) {π}_{0}^{gen} ← train\_DDPM ( 𝒟 ) .$
$Step 3 : Collect on - generator dataset {𝒢}^{'} \sim rollout ( 𝒪 , {π}_{0}^{gen} ) .$
Step 4: Annotate the on-generator samples using simulation { [symbol] ⁺, [symbol] ⁻} ← simulate( [symbol] , [symbol] );
Step 5: Aggregate annotated on-generator data [symbol] ← [symbol] ∪ { [symbol] ⁺, [symbol] ⁻};
$Step 6 : Train the grasp discriminator {π}_{t}^{dis} ← train\_classifier ( 𝒟 , {π}_{0}^{gen} ) ;$
Output: Trained grasp diffusion model π^{gen}, Trained grasp discriminator model π_{dis}.

### Robot Control Using Trained Grasp Diffusion Model and Trained Grasp Discriminator Model

FIG. 4 is a more detailed illustration of robot control application 146, according to various embodiments. As shown, robot control application 146 includes, without limitation, a sensor data processing module 410, object geometry encoder 123, a grasp pose generation module 411, and a motion planning module 412. In operation, sensor processing module 410 processes senor data 402 received from sensor 180 and generates object geometry data 401. Object geometry encoder 123 processes object geometry data 401 and generates object geometry embedding 403. Grasp pose generation module 411 uses grasp diffusion model 121 to process object geometry embedding 403 and generate one or more grasp poses 404. Grasp pose generation module 411 then uses grasp discriminator module 122 to process grasp poses 404 and generate filtered grasp poses 405. Motion planning module 412 processes filtered grasp poses 405 and generates a grasp robot plan (also referred to herein as a “grasping plan”). Robot control application 146 uses the grasp robot plan to cause robot 160 to grasp an object.

Sensor data processing module 410 is a module of robot control application 146 which processes sensor data 402 and generates object geometry data 401. In some embodiments, sensor data 402 includes raw data from one or more perception sources, such as RGB cameras, depth sensors, LiDAR, stereo vision systems, RGB-D cameras. In some embodiments, sensor data processing module 410 extracts 3D information from the raw sensor data 402 and converts the 3D information into a structured geometric representation of one or more objects in the scene. In at least one example, sensor data 402 is captured using an Intel RealSense D435 RGB-D camera extrinsically calibrated to a UR10 robotic manipulator, overlooking a tabletop workspace. In some embodiments, sensor data processing module 410 includes stereo reconstruction, depth estimation, and object segmentation submodules to generate object geometry data 401. In some embodiments, sensor data processing module 410 can estimate using, e.g., FoundationStereo, high-quality depth maps from monocular or stereo images included in sensor data 402, and use a segmentation model, such as Segment Anything Model 2 (SAM2), to perform instance segmentation for isolating individual objects in cluttered scenes. Sensor data processing module 410 then fuses the resulting segmented depth data to construct a per-object point cloud, which is encoded as object geometry data 401.

Object geometry encoder 123 processes object geometry data 401 and generates object geometry embedding 403. As described, in some embodiments, object geometry encoder 123 includes a transformer-based architecture trained to extract geometric features from unstructured point cloud data included in object geometry data 403. For example, Object geometry encoder 123 could include a PTv3 model, which first serializes the unstructured point cloud into a structured sequence (e.g., a serialized representation) and then applies a transformer to process the serialized representation. Object geometry embedding 403 includes a latent representation that captures the spatial and structural characteristics of the object geometry included in object geometry data 401.

Grasp pose generation module 411 is a module of robot control application 146 that processes object geometry embedding 403 and generates filtered grasp poses 405. In some embodiments, grasp pose generation module 411 uses grasp diffusion model 121 to process object geometry embedding 403 and generate grasp poses 404. In such cases, grasp pose generation module 411 uses grasp diffusion model 121 to perform an iterative denoising (i.e., reverse diffusion) process starting from randomly sampled noisy grasp poses, conditioned on object geometry embedding 403, to generate one or more physically plausible 6-DOF grasp poses 404. In some embodiments, the candidate grasp poses 404 can include multiple options positioned around the target object with varying orientations and approach vectors. In some embodiments, grasp pose generation module 411 uses grasp discriminator model 122 to process grasp poses 404 and generate filtered grasp poses 405. In some embodiments, grasp discriminator model 122 processes each grasp pose included in grasp poses 404 and object geometry embedding 403 and generates a predicted grasp pose score 324, which includes a success score. For example, the score can be a continuous value between 0 and 1, where values closer to 1 indicate a high likelihood of resulting in a stable and executable grasp. Based on the scores, grasp pose generation module 411 ranks the candidate grasp poses 404 and selects a subset of the highest scoring grasp poses 404, generating filtered grasp poses 405. In some embodiments, grasp pose generation module 411 retains a fixed number of top-ranked grasp poses 404 (e.g., top-100 ranked grasp poses). In some embodiments, grasp pose generation module 411 uses a threshold-based filter to exclude any grasp poses 404 with a score below a predefined value (e.g., 0.7). For example, when grasp diffusion model generates 2,000 candidate grasp poses 404 for an object, grasp discriminator model 122 can assign scores such as 0.92, 0.85, 0.43, etc., and grasp pose generation module 411 can retain only those poses with scores above 0.8.

Motion planning module 412 is a module of robot control application 146 which processes filtered grasp poses 405 and generates a grasp robot plan. In some embodiments, motion planning module 412 evaluates filtered grasp poses 405 based on kinematic feasibility and collision constraints within the environment of robot 160. For each filtered grasp pose 405, motion planning module 412 attempts to compute a valid grasp robot plan (e.g., trajectory) that moves the end-effector of robot 160 from the current position to the target filtered grasp pose 405 without colliding with obstacles or violating joint, velocity, or acceleration limits. In some embodiments, motion planning module 412 uses a motion planning framework, such as Compute Unified Device Architecture (CUDA)-accelerated motion planning library for real-time robotic systems (cuRobo), Rapidly-exploring Random Tree Star (RRT*), an optimization-based solver, and/or the like, to search for feasible grasp robot plans in the configuration space of robot 160. During the search, motion planning module 412 discards filtered grasp poses 405 that result in trajectories intersecting with known objects or the environment. In some embodiments, motion planning module 412 uses a voxel- or mesh-based collision representation of the workspace of robot 160, such as NVIDIA Block-Based Collision Model (NVBlock), to detect and filter out trajectories that result in collisions. In some embodiments, among the remaining feasible filtered grasp poses 405, motion planning module 412 selects the filtered grasp pose 405 associated with the lowest-cost grasp robot plan (e.g., lowest-cost trajectory). In some embodiments, motion planning module 412 computes the cost based on total trajectory length in joint space, execution time, energy consumption, or a weighted combination of one or more factors. For example, when two filtered grasp poses 405 are reachable for robot 160, motion planning module 412 can select the feasible grasp pose 405 requiring the shortest trajectory to minimize execution latency.

In some embodiments, robot control application 146 processes the grasp robot plan and generates one or more controls to cause robot 160 to grasp an object. In some embodiments, robot control application 146 processes the grasp robot plan and generates low-level control commands (e.g., controls), such as joint position, velocity, or torque setpoints. In some embodiments, robot control application 146 uses an inverse kinematics solver and a trajectory tracking controller to permit that the end-effector of robot 160 follows the grasp robot plan. In some embodiments, upon reaching the filtered grasp pose 405, robot control application 146 triggers the gripper to close or activate (e.g., by applying a gripping force or enabling a suction mechanism), thereby securing the object. In some embodiments, robot control application 146 also monitors force sensors or gripper state feedback to confirm that the object has been successfully grasped.

FIG. 5 is a more detailed illustration of grasp diffusion model 121, according to various embodiments. As shown, grasp diffusion model 121 includes a position encoder 510, a multi-layer perceptron 511, and one or more attention layers 512. In operation, position encoder 510 processes time step 501 and generates time step embedding 504. Multi-layer perceptron 511 processes noisy grasp pose 505 and generates noisy grasp pose embedding 503. Attention layers 512 process object geometry embedding 505, time step embedding 504, and noisy grasp pose embedding 504 and generate predicted noise 514.

Position encoder 510 is a machine learning model, such as a neural network, which processes time step 501 and generates time step embedding 504. In some embodiments, time step 501 corresponds to a scalar diffusion timestep t∈{1, . . . , T} used during the denoising process of grasp diffusion model 121. In some embodiments, position encoder 510 encodes the scalar value into a high-dimensional vector representation that captures temporal information. In some embodiments, position encoder 510 uses sinusoidal or learned embeddings to represent the timestep, similar to encodings used in transformer-based architectures. In some embodiments, position encoder 510 includes a multilayer perceptron that maps the scalar timestep into a learned feature space.

Multilayer perceptron 511 is a machine learning model, such as a neural network, which processes noisy grasp pose 505 and generates noisy grasp pose embedding 503. In some embodiments, noisy grasp pose 505 represents a 6-DOF noisy grasp pose at a particular diffusion timestep, expressed either in SE(3) or as separate translation and rotation components. Multilayer perceptron 511 transforms the noisy grasp pose 505 into a high-dimensional feature vector that encodes spatial information relevant for the denoising process. In some embodiments, multilayer perceptron 511 normalizes or expresses noisy grasp pose 505 using exponential map representations for rotation and scaled translation vectors. In some embodiments, multilayer perceptron 511 includes one or more fully connected layers with non-linear activation functions, such as Rectified Linear Unit (ReLU), Gaussian Error Linear Unit (GELU), and/or the like, to capture dependencies within noisy grasp pose505.

Attention layers 512 process time step embedding 504, object geometry embedding 502, and noisy grasp pose embedding 503 and generate predicted noise 514. In some embodiments, attention layers 512 include a transformer-based architecture that uses self-attention and/or cross-attention mechanisms to integrate and relate features from time step embedding 504, object geometry embedding 502, and noisy grasp pose embedding 503. The time step embedding 504 provides temporal context about the stage of the diffusion process, object geometry embedding 502 encodes the spatial structure of the object derived from the point cloud, and the noisy grasp pose embedding 503 encodes the current state of the candidate grasp pose undergoing denoising. Attention layers 512 attend over time step embedding 504, object geometry embedding 502, and noisy grasp pose embedding 503 to learn interactions between the object geometry and the grasp pose in a temporally conditioned manner. In some embodiments, attention layers 512 include multi-head self-attention to extract relationships across spatial and temporal features. In some embodiments, attention layers 512 include additional feedforward layers to generate predicted noise 514. In some embodiments, predicted noise 514 is used in a reverse diffusion update equation, such as the DDPM update rule described in Equation 2, to compute the next noisy grasp pose 505 for the previous timestep (e.g., gₜ₋₁).

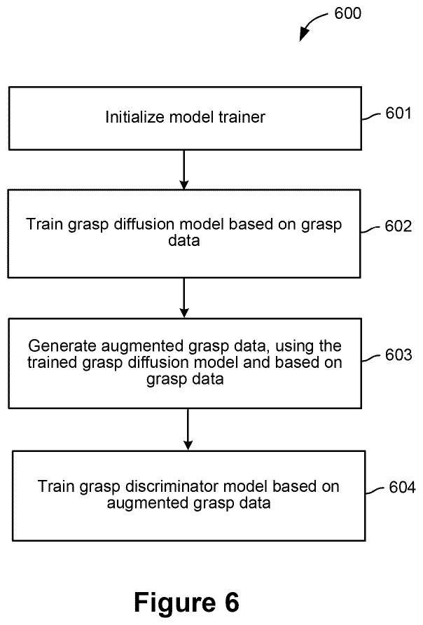

FIG. 6 is a flow diagram of method steps for training grasp diffusion model 121 and grasp discriminator model 122, according to various embodiments. Although the method steps are described in conjunction with the systems of FIGS. 1-5, persons skilled in the art will understand that any system configured to perform the method steps in any order falls within the scope of the present disclosure.

As shown, a method 600 begins with step 601, where model trainer 114 is initialized. In some embodiments, model trainer 114 initializes the number of diffusion steps T, which defines the length of the forward and reverse diffusion processes. Model trainer 114 also initializes the number of transformer layers, attention layers, and hidden dimensions used in the grasp diffusion model 121, as well as the depth and width of various multilayer perceptrons, such as multilayer perceptron 511. In addition, model trainer 114 initializes the batch size for training (e.g., number of objects or grasp poses included in grasp data 117 processed per optimization step), the optimizer type (e.g., Adam), learning rate, weight decay parameters, and/or the like. In some embodiments, model trainer 114 initializes batches of grasp training data, such as selecting positively labeled grasp poses [symbol] ⁺⊆ [symbol] . In some embodiments, model trainer 114 initializes training schedules, such as balancing strategies for positive grasp labels and negative grasp labels from augmented grasp data 118.

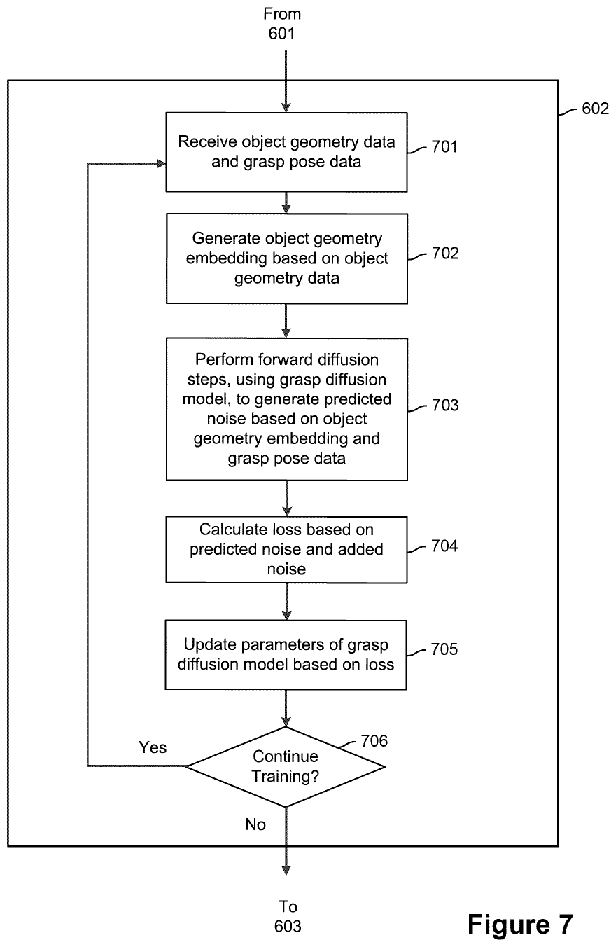

At step 602, model trainer 114 trains grasp diffusion model 121 based on grasp data 117. In some embodiments, object geometry encoder 123 processes object geometry data 306 and generates object geometry embedding 303. Model trainer 114 uses grasp diffusion model 121 to process object geometry embedding 303 and performs forward diffusion steps to generate a predicted noise. During the forward diffusion steps, model trainer 114 adds noise to a grasp pose included in the grasp pose data 307 and generates a noisy grasp pose at each forward diffusion time step. In some embodiments, grasp diffusion model 121 processes the noisy grasp pose, the time step, and object geometry embedding 303 and generates a predicted noise. Loss calculator 116 compares the predicted noise with the added noise and calculates loss 301. Model trainer 114 uses loss 301 to iteratively update parameters of grasp diffusion model 121 until one or more stopping criteria are met. Once training of grasp diffusion model 121 is completed, model trainer 114 stores the trained grasp diffusion model 121 in datastore 120 or elsewhere. Step 602 is described in greater detail in conjunction with FIG. 7.

At step 603, grasp generator 119 generates augmented grasp data 118, using the trained grasp diffusion model 121 and based on grasp data 117. Grasp generator 119 includes, without limitation, trained grasp diffusion model 121. In operation, object geometry encoder 123 processes object geometry data 306 and generates object geometry embedding 303. Grasp generator 119 uses trained grasp diffusion model 121 to process object geometry embedding 303 and generate predicted grasp pose 313. Simulator 116 simulates predicted grasp pose 313 and generates corresponding grasp pose label 314. Grasp generator 119 then stores predicted grasp pose 313 and grasp pose label 314 in on-generator grasp pose data 315. In some embodiments, grasp data 117 and on-generator grasp pose data 315 are stored in augmented grasp data 118. Step 603 is described in greater detail in conjunction with FIG. 8.

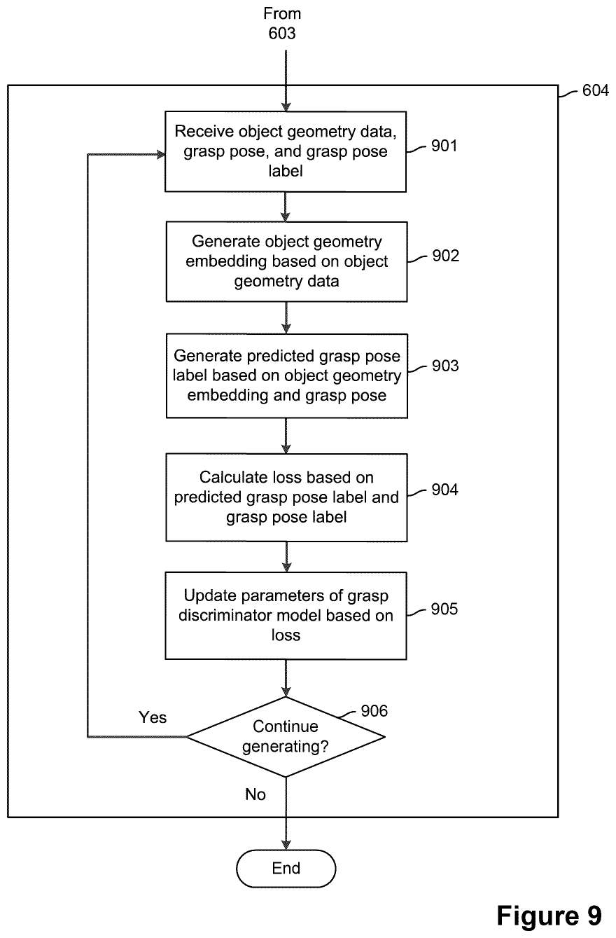

At step 604, model trainer 114 trains grasp discriminator model 122 based on augmented grasp data 118. In some embodiments, object geometry encoder 123 processes object geometry data 306 and generates object geometry embedding 303. Grasp discriminator model 122 processes object geometry embedding 303 and grasp pose 321 included in augmented grasp data 118 and generates predicted grasp pose score 324. Loss calculator 116 compares predicted grasp pose score 324 and grasp pose label 322 included in augmented grasp data 118 and calculates loss 323. Model trainer 114 uses loss 323 to iteratively update parameters of grasp discriminator model 122 until one or more stopping criteria are met. Once grasp discriminator model 122 is trained, model trainer 114 stores the trained grasp discriminator model 122 in datastore 120 or elsewhere. Step 604 is described in greater detail in conjunction with FIG. 9.

FIG. 7 is a flow diagram of method steps for training grasp diffusion model 121, according to various embodiments. Although the method steps are described in conjunction with the systems of FIGS. 1-5, persons skilled in the art will understand that any system configured to perform the method steps in any order falls within the scope of the present disclosure.

As shown, step 602 of method 600 begins with step 701, where grasp diffusion model 121 receives object geometry data 306 and object geometry encoder 127 receives grasp pose data 307. Object geometry data 306 [symbol] includes the 3D shape of one or more objects, such as a point cloud, polygon mesh, or other geometric representation derived from a sensor input or simulation. Grasp pose data 307 includes one or more 6-DOF gripper transformations, each specifying a position and orientation of a robotic end-effector relative to an object. In some embodiments, each grasp pose 321 included in grasp pose data 307 is accompanied with a grasp pose label 322, indicating grasp success or failure. In some embodiments, the grasp pose label 322 includes a success rate, such as a value between zero and one, rather than a binary label. In at least one example, the grasp pose label is determined through a simulated shaking procedure following the ACRONYM pipeline. A grasp pose 321 is labeled as successful, when a stable contact configuration remains after the object is shaken within the gripper. In some embodiments, the object meshes included in object geometry data 306 can be selected from a publicly available collection of 3D object geometry dataset, such as the Objaverse dataset. In some embodiments, grasp pose data 307 includes grasp poses 321 for various types of grippers including but not limited to antipodal grippers. In some embodiments, grasp pose data 307 includes grasp poses for a suction-based gripper. In some embodiments, for a suction gripper, grasp success labels included in the grasp pose labels 322 are computed using an analytical contact model.

At step 702, object geometry encoder 123 generates object geometry embedding 303 based on object geometry data 306. As described, in some embodiments, object geometry encoder 123 includes a transformer-based architecture trained to extract geometric features from unstructured point cloud data included in object geometry data 306. For example, object geometry encoder 123 could include a PTv3 model, which first serializes the unstructured point cloud included in object geometry data 306 into a structured sequence (e.g., a serialized representation) and then applies a transformer to process the serialized representation. In some embodiments, object geometry encoder 123 is trained jointly with grasp diffusion model 121. In some embodiments, object geometry encoder 123 is pre-trained and reused in a frozen state during inference or when training grasp diffusion model 121.

At step 703, model trainer 114 performs forward diffusion steps, using grasp diffusion model 121, to generate predicted noise 514 based on object geometry embedding 303 and grasp pose data 307. In some embodiments, model trainer 114 uses grasp diffusion model 121 to process object geometry embedding 303 and grasp pose data 307 and performs forward diffusion steps to generate a predicted noise 514. During the forward diffusion steps, model trainer 114 adds noise to a grasp pose 321 included in the grasp pose data 307 and generates a noisy grasp pose 505 at each forward diffusion time step. In some embodiments, the forward diffusion process begins with a clean grasp pose g₀∈ [symbol] ⁺, where [symbol] ⁺ is the set of grasp poses labeled as successful included in grasp pose data 307. Model trainer 114 samples a diffusion timestep 501 t∈{1, . . . , T} and adds Gaussian noise to the clean pose g₀ to generate a noisy grasp pose 505 gₜ, according to a predefined noise schedule, such as a cosine schedule. In some embodiments, the forward diffusion process can follow the DDPM formulation as described in Equation 3. Grasp diffusion model 121 then processes the resulting noisy grasp pose 505 gₜ, the timestep 501 t and object geometry embedding 303 and generates predicted noise 514 \grave{∈}. In some embodiments, grasp diffusion model 121 can be represented by a parametric function as described in Equation 4.

At step 704, model trainer 114 calculates loss 301 based on predicted noise 514 and added noise. In some embodiments, loss calculator 116 calculates a denoising loss that quantifies the difference between the predicted noise 514 and the added noise using a squared L2 norm. In some embodiments, the denoising loss is calculated as described in Equation 5. In some embodiments, loss calculator 116 separately applies the L2 loss to the rotation and translation components of the grasp pose.

At step 705, model trainer 114 updates parameters of grasp diffusion model 121 based on loss 301. In some embodiments, model trainer 114 performs gradient-based optimization, such as SGD, Adam, or another adaptive optimizer to minimize loss 301 across batches of training samples from grasp data 117.

At step 706, model trainer 114 determines whether to continue training. In some embodiments, training is performed over a fixed number of epochs or iterations. In some embodiments, model trainer 114 applies dynamic stopping criteria based on model performance on a held-out validation set. For example, training can stop once a validation loss falls below a predetermined threshold or when improvements in validation loss fall below a defined tolerance over a specified number of epochs (e.g., early stopping). In some embodiments, model trainer 114 includes stopping criteria based on convergence behavior, such as when the moving average of the training loss 301 stabilizes, or when gradients fall below a minimum magnitude, indicating that additional updates are unlikely to improve performance. Whenever model trainer 114 determines to continue training, step 602 returns to step 701. Whenever model trainer 114 determines not to continue training, method 600 proceeds to step 603.

FIG. 8 is a flow diagram of method steps for generating augmented grasp data 118, according to various embodiments. Although the method steps are described in conjunction with the systems of FIGS. 1-5, persons skilled in the art will understand that any system configured to perform the method steps in any order falls within the scope of the present disclosure.

As shown, step 603 of method 600 begins with step 801, where object geometry encoder 123 receives object geometry data 306. Object geometry data 306 [symbol] includes the 3D shape of one or more objects, such as a point cloud, polygon mesh, or other geometric representation derived from a sensor input or simulation. In some embodiments, the object meshes included in object geometry data 306 can be selected from a publicly available collection of 3D object geometry dataset, such as the Objaverse dataset.

At step 802, object geometry encoder 123 generates object geometry embedding 303 based on object geometry data 123. As described, in some embodiments, object geometry encoder 123 includes a transformer-based architecture trained to extract geometric features from unstructured point cloud data included in object geometry data 306. For example, object geometry encoder 123 could include a PTv3 model, which first serializes the unstructured point cloud included in object geometry data 306 into a structured sequence (e.g., a serialized representation) and then applies a transformer to process the serialized representation.

At step 803, grasp generator 119 generates predicted grasp pose 313, using the trained grasp diffusion model 121, based on object geometry embedding 303. In some embodiments, grasp generator 119 performs a reverse diffusion process to process object geometry embedding 303 and generate predicted grasp pose 313. In some embodiments, the reverse diffusion process begins by sampling an initial noisy grasp pose g_{T}˜ [symbol] (0,I) from a standard multivariate Gaussian distribution in the latent SE(3) space. Grasp generator 119 then uses the trained grasp diffusion model 121 to iteratively denoise the noisy grasp pose 505 g_{T} for a fixed number of reverse diffusion time steps 501 (e.g., T=10) and generate a clean grasp pose g₀ (e.g., predicted grasp pose 313). At each timestep 501 t∈{T, T−1, . . . , 1}, grasp generator 119 inputs the noisy grasp pose 505 gₜ, the timestep 501 t, and the object geometry embedding 303 into the trained grasp diffusion model 121, which generates the predicted noise 514, such as using Equation 4. In some embodiments, the predicted noise 514 is then used to compute the next denoised sample (e.g., noisy grasp pose 505) gₜ₋₁ using the DDPM reverse update rule as described in Equation 2. The denoising process is repeated until the clean predicted grasp pose 313 g₀ is obtained. In some embodiments, grasp generator 119 operates on grasp poses that are factorized into separate translation and rotation components in [symbol] ³ and SO(3), respectively, and grasp diffusion model 119 is configured to denoise the translation and rotation components separately by running two separate denoising processes-one for translation and one for rotation—each with a dedicated noise schedule. In some embodiments, predicted grasp pose 313 can be represented as a 4×4 homogeneous transformation matrix, which combines the predicted translation and rotation into a single SE(3) pose that can be executed by a robotic end-effector in physical space.

At step 804, simulator 116 generates grasp pose label 314 based on predicted grasp pose 313. In some embodiments, simulator 116 applies predicted grasp pose 313 to a virtual robotic end-effector within a simulated environment and evaluates whether predicted grasp pose 313 is successful based on simulated physical interaction with a target object. In some embodiments, simulator 116 checks whether the virtual robotic end-effector can perform predicted grasp pose 313 without collisions. In some embodiments, simulator 116 includes dynamic physics modeling, including but not limited to gravity, collisions, and frictional contact between the gripper and the object. For example, simulator 116 can simulate the gripper approaching the object, closing around the object, and executing a shaking motion to assess grasp stability such that a predicted grasp pose 313 is labeled as successful whenever the object remains securely held after the shaking procedure is completed. In some embodiments, simulator 116 includes a labeling protocol used in simulation-based benchmarks, such as ACRONYM or similar grasping frameworks. In some embodiments, grasp pose label 314 is a binary label (e.g., success or failure). In some embodiments, grasp pose label 314 includes a continuous-valued score reflecting grasp stability, contact force margins, or other physical metrics. In some embodiments, simulator 116 is configured to evaluate predicted grasp poses 313 for different gripper types, such as parallel-jaw grippers, suction-based grippers, and/or the like, using either physics-based or analytical models depending on the gripper modality.

At step 804, grasp generator 119 stores grasp pose label 314 and predicted grasp pose 313 in on-generator grasp pose data 315.

At step 805, grasp generator 119 determines whether to continue. In some embodiments, grasp generator 119 continues to generate predicted grasp poses 313 until a pre-defined number of predicted grasp poses 313 are generated. In some embodiments, grasp generator 119 continues to generate predicted grasp poses 313 for a fixed number of object geometries included in object geometry data 306. Whenever grasp generator 119 determines to continue generating, the step 603 returns to step 801. Whenever grasp generator 119 determines not to continue generating, the step 603 proceeds to step 806.

At step 806, grasp generator 119 stores on-generator grasp data 315 in augmented grasp data 118. Augmented grasp data 118 includes on-generator grasp pose data 315 and grasp data 117. In some embodiments, augmented grasp data 118 includes the union of grasp data 117 [symbol] and on-generator grasp data 315 [symbol] ⁺∪ [symbol] ⁻, where [symbol] ⁺ denotes the set of predicted grasp poses 313 with successful grasp pose label 314 and [symbol] ⁻ denotes the set of predicted grasp poses 313 with unsuccessful grasp pose label 314.

FIG. 9 is a flow diagram of method steps for training grasp discriminator model 122, according to various embodiments. Although the method steps are described in conjunction with the systems of FIGS. 1-5, persons skilled in the art will understand that any system configured to perform the method steps in any order falls within the scope of the present disclosure.

At step 901, object geometry encoder 123 receives object geometry data 306, grasp discriminator model 122 receives grasp pose 321, and loss calculator 116 receives grasp pose label 322. Grasp pose 321 includes one or more 6-DOF gripper transformations, each specifying a position and orientation of a robotic end-effector relative to an object. In some embodiments, each grasp pose 321 included in grasp pose data 307 is accompanied with a grasp pose label 322, indicating grasp success or failure. In some embodiments, the grasp pose label 322 includes a success rate, such as a value between zero and one, rather than a binary label. In at least one example, the grasp pose label 322 is determined through a simulated shaking procedure following the ACRONYM pipeline. A grasp pose 321 is labeled as successful, when a stable contact configuration remains after the object is shaken within the gripper. In some embodiments, grasp pose data 307 includes grasp poses 321 for various types of grippers. In some embodiments, grasp pose data 307 includes grasp poses for a suction-based gripper. In some embodiments, for a suction gripper, grasp success labels included in grasp pose labels 322 are computed using an analytical contact model.

At step 902, object geometry encoder 123 generates object geometry embedding 303 based on object geometry data 306. As described, in some embodiments, object geometry encoder 123 includes a transformer-based architecture trained to extract geometric features from unstructured point cloud data included in object geometry data 306. For example, object geometry encoder 123 could include a PTv3 model, which first serializes the unstructured point cloud included in object geometry data 306 into a structured sequence (e.g., a serialized representation) and then applies a transformer to process the serialized representation.

At step 903, grasp discriminator model 122 generates predicted grasp pose score 324 based on object geometry embedding 303 and grasp pose 321. In some embodiments, grasp discriminator model 122 includes a binary classifier that predicts whether a given grasp pose 321 is likely to be successful or unsuccessful, conditioned on the geometry of the target object included in object geometry embedding 303. In some embodiments, grasp discriminator model 122 includes a multilayer perceptron, a transformer-based architecture, and/or the like. In some embodiments, predicted grasp pose score 324 is a continuous-valued score between 0 and 1 that represents confidence that grasp pose 321 will result in a stable and successful grasp. In some implementations, predicted grasp pose score 324 includes a grasp success probability, where values closer to 1 indicate higher confidence of success and values closer to 0 indicate higher likelihood of failure. In some embodiments, grasp discriminator model 122 uses a fixed threshold to generate predicted grasp pose score 324 as a binary grasp success/failure prediction.

At step 904, loss calculator 116 calculates loss 323 based on predicted grasp pose score 324 and grasp pose label 322. In some embodiments, loss calculator 116 calculates a binary classification loss, such as binary cross-entropy loss, which measures the divergence between predicted grasp success score (e.g., predicted grasp pose score 324) \grave{y}∈[0,1] generated by grasp discriminator model 122 and the ground-truth label (e.g., grasp pose label 322) y∈{0,1}. In some embodiments, loss 323 is calculated as described in Equation 6, which penalizes confident incorrect predicted grasp pose scores 324 more heavily and encourages grasp discriminator model 122 to generate output scores (e.g., predicted grasp pose labels 324) that align with the observed labels (e.g., grasp pose label 322). In some embodiments, loss calculator 116 calculates loss 323 over a batch of predicted grasp pose scores 324 and returns the average loss across the batch.

At step 905, model trainer 114 updates parameters of grasp discriminator model 122 based on loss 323. In some embodiments, model trainer 114 uses batches of augmented grasp data 118 with an equal split between grasp pose data 307 and on-generator grasp pose data 315, and with a balanced distribution of successful and unsuccessful grasp pose labels 322. In some embodiments, model trainer 114 minimizes loss 323 using a gradient-based optimization algorithm, such as SGD, Adam, and/or the like.

At step 906, model trainer 114 determines whether to continue training. In some embodiments, model trainer 114 updates the parameters of grasp discriminator model 122 for a fixed number of epochs or until a stopping criterion is met. In some embodiments, the stopping criteria include convergence of the training loss 323, stabilization of a validation loss, or failure to improve validation performance beyond a defined threshold over a specified number of epochs (e.g., early stopping). In some embodiments, model trainer 114 monitors gradient norms and training terminates when gradients fall below a minimum threshold, indicating diminishing returns from further updates. Whenever model trainer 114 determines to continue training, step 604 returns to step 901. Whenever model trainer 114 determines not to continue training, the method 600 terminates.

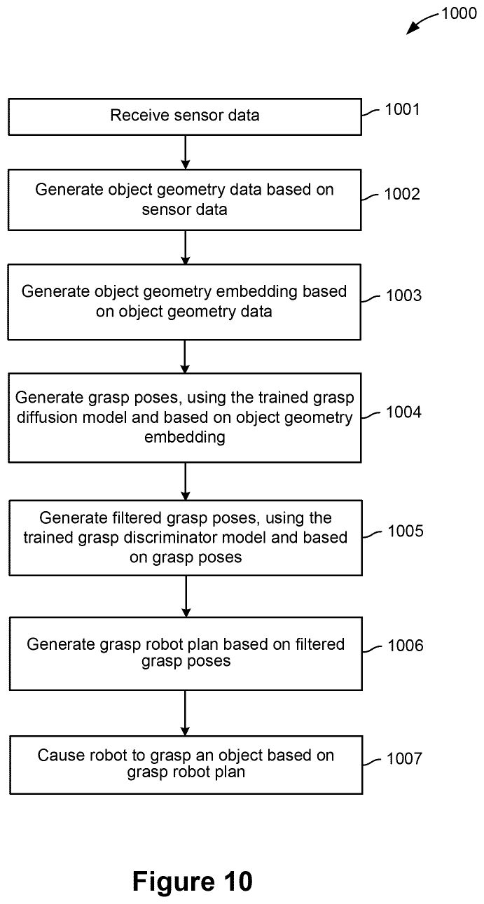

FIG. 10 is a flow diagram of method steps for controlling robot 160, according to various embodiments. Although the method steps are described in conjunction with the systems of FIGS. 1-5, persons skilled in the art will understand that any system configured to perform the method steps in any order falls within the scope of the present disclosure.

As shown, a method 1000 begins with step 1001, where sensor data processing module 410 receives sensor data 402. In some embodiments, sensor data 402 includes raw data from one or more perception sources, such as RGB cameras, depth sensors, LiDAR, stereo vision systems, RGB-D cameras.

At step 1002, sensor data processing module 410 generates object geometry data 401 based on sensor data 402. In some embodiments, sensor data processing module 410 extracts 3D information from raw sensor data 402 and converts the 3D information into a structured geometric representation of one or more objects in the scene. In some embodiments, sensor data processing module 410 includes stereo reconstruction, depth estimation, and object segmentation submodules to generate object geometry data 401. In some embodiments, sensor data processing module 410 estimates using, e.g., FoundationStereo, high-quality depth maps from monocular or stereo images included in sensor data 402, and applies a segmentation model, such as SAM2, to perform instance segmentation for isolating individual objects in cluttered scenes. Sensor data processing module 410 then fuses the resulting segmented depth data to construct a per-object point cloud, which is encoded as object geometry data 401.

At step 1003, object geometry encoder 123 generates object geometry embedding 403 based on object geometry data 401. As described, in some embodiments, object geometry encoder 123 includes a transformer-based architecture trained to extract geometric features from unstructured point cloud data included in object geometry data 403. For example, Object geometry encoder 123 could include a PTv3 model, which first serializes the unstructured point cloud into a structured sequence (e.g., a serialized representation) and then applies a transformer to process the serialized representation. Object geometry embedding 403 includes a latent representation that captures the spatial and structural characteristics of the object geometry included in object geometry data 401.

At step 1004, grasp pose generation module 411 generates grasp poses 404, using the trained grasp diffusion model 121 and based on object geometry embedding 403. In some embodiments, grasp pose generation module 411 uses grasp diffusion model 121 to perform an iterative denoising (i.e., reverse diffusion) process starting from randomly sampled noisy grasp poses, conditioned on object geometry embedding 403, to generate one or more physically plausible 6-DOF grasp poses 404. In some embodiments, the candidate grasp poses 404 can include multiple options positioned around the target object with varying orientations and approach vectors. Step 1004 is described in greater detail in conjunction with FIG. 11.

At step 1005, grasp pose generation module 411 generates filtered grasp poses 405, using the trained grasp discriminator model 122 and based on grasp poses 404. In some embodiments, grasp discriminator model 122 processes each grasp pose included in grasp poses 404 and object geometry embedding 403 and generates a predicted grasp pose score 324, which includes a success score. For example, the score could be a continuous value between 0 and 1, where values closer to 1 indicate a high likelihood of resulting in a stable and executable grasp. Based on the scores, grasp pose generation module 411 ranks the candidate grasp poses 404 and selects a subset of the highest scoring grasp poses 404, generating filtered grasp poses 405. In some embodiments, grasp pose generation module 411 retains a fixed number of top-ranked grasp poses 404 (e.g., top-100 grasp poses). In some embodiments, grasp pose generation module 411 uses a threshold-based filter to exclude any grasp poses 404 with a score below a predefined value (e.g., 0.7).

At step 1006, motion planning module 412 generates grasp robot plan based on filtered grasp poses 405. In some embodiments, motion planning module 412 evaluates filtered grasp poses 405 based on kinematic feasibility and collision constraints within the environment of robot 160. For each filtered grasp pose 405, motion planning module 412 attempts to compute a valid grasp robot plan (e.g., trajectory) that moves the end-effector of robot 160 from the current position to the target filtered grasp pose 405 without colliding with obstacles or violating joint, velocity, or acceleration limits. In some embodiments, motion planning module 412 uses a motion planning framework, such as cuRobo, RRT*, an optimization-based solver, and/or the like, to search for feasible grasp robot plans in the configuration space of robot 160. During the search, motion planning module 412 discards filtered grasp poses 405 that result in trajectories intersecting with known objects or the environment. In some embodiments, motion planning module 412 uses a voxel- or mesh-based collision representation of the workspace of robot 160, such as NVBlock, to detect and filter out trajectories that result in collisions. In some embodiments, among the remaining feasible filtered grasp poses 405, motion planning module 412 selects the filtered grasp pose 405 associated with the lowest-cost grasp robot plan. In some embodiments, motion planning module 412 computes the cost based on total trajectory length in joint space, execution time, energy consumption, or a weighted combination of one or more factors. For example, when two filtered grasp poses 405 are reachable for robot 160, motion planning module 412 can select the feasible grasp pose 405 requiring the shortest trajectory to minimize execution latency.

At step 1007, robot control application 146 causes robot 160 to grasp an object based on grasp robot plan. In some embodiments, robot control application 146 processes the grasp robot plan and generates one or more controls to cause robot 160 to grasp an object. In some embodiments, robot control application 146 processes the grasp robot plan and generates low-level control commands (e.g., controls), such as joint position, velocity, or torque setpoints. In some embodiments, robot control application 146 uses an inverse kinematics solver and a trajectory tracking controller to permit that the end-effector of robot 160 follows the grasp robot plan. In some embodiments, upon reaching the filtered grasp pose 405, robot control application 146 triggers the gripper to close or activate (e.g., by applying a gripping force or enabling a suction mechanism), thereby securing the object. In some embodiments, robot control application 146 also monitors force sensors or gripper state feedback to confirm that the object has been successfully grasped.

FIG. 11 is a flow diagram of method steps for generating grasp poses 404, according to various embodiments. Although the method steps are described in conjunction with the systems of FIGS. 1-5, persons skilled in the art will understand that any system configured to perform the method steps in any order falls within the scope of the present disclosure.

As shown, step 1004 of method 1000 begins with step 1101, where grasp diffusion model 121 receives object geometry embedding 502. In some embodiments, object geometry embedding 502 is generated by processing object geometry data 401 using a machine learning model, such as object geometry encoder 123, that processes the object geometry data and generates object geometry embedding 502.

At step 1102, grasp diffusion model 121 receives time step 501 and noisy grasp pose 505. In some embodiments, time step 501 corresponds to a scalar diffusion timestep t∈{1, . . . , T} used during the denoising process of grasp diffusion model 121. In some embodiments, grasp diffusion model 121 samples an initial noisy grasp pose 505 g_{T}˜ [symbol] (0,I) from a standard multivariate Gaussian distribution in the latent SE(3) space.

At step 1103, position encoder 510 generates time step embedding 504 based on time step 501. In some embodiments, position encoder 510 encodes the scalar value into a high-dimensional vector representation that captures temporal information. In some embodiments, position encoder 510 uses sinusoidal or learned embeddings to represent the timestep, similar to encodings used in transformer-based architectures. In some embodiments, position encoder 510 includes a multilayer perceptron that maps the scalar timestep into a learned feature space.

At step 1104, multilayer perceptron 511 generates noisy grasp pose embedding 502 based on noisy grasp pose 505. In some embodiments, noisy grasp pose 505 represents a 6-DOF noisy grasp pose at a particular diffusion timestep, expressed either in SE(3) or as separate translation and rotation components. Multilayer perceptron 511 transforms the noisy grasp pose 505 into a high-dimensional feature vector that encodes spatial information relevant for the denoising process. In some embodiments, multilayer perceptron 511 normalizes or expresses noisy grasp pose 505 using exponential map representations for rotation and scaled translation vectors. In some embodiments, multilayer perceptron 511 includes one or more fully connected layers with non-linear activation functions, such as ReLU, GELU, and/or the like, to capture dependencies within noisy grasp pose 505. In some embodiments, step 1103 and step 1104 are performed concurrently or sequentially.

At step 1105, attention layers 512 generate predicted noise 514 based on time embedding 504, noisy grasp pose embedding 503, and object geometry embedding 502. In some embodiments, attention layers 512 include a transformer-based architecture that uses self-attention and/or cross-attention mechanisms to integrate and relate features from time step embedding 504, object geometry embedding 502, and noisy grasp pose embedding 503. Time step embedding 504 provides temporal context about the stage of the diffusion process, object geometry embedding 502 encodes the spatial structure of the object derived from the point cloud, and noisy grasp pose embedding 503 encodes the current state of the candidate grasp pose undergoing denoising. Attention layers 512 attend over time step embedding 504, object geometry embedding 502, and noisy grasp pose embedding 503 to learn interactions between the object geometry and the grasp pose in a temporally conditioned manner. In some embodiments, attention layers 512 include multi-head self-attention to extract relationships across spatial and temporal features. In some embodiments, attention layers 512 include additional feedforward layers to generate predicted noise 514.

At step 1107, grasp pose generation module 411 checks whether it is the last time step 501. In some embodiments, the last time step 501 during the denoising process corresponds to t=1. Whenever grasp pose generation module 411 determines that it is not the last time step 501, the step 1004 returns to step 1102. In some embodiments, predicted noise 514 is used in a reverse diffusion update equation, such as the DDPM update rule described in Equation 2, to compute the next noisy grasp pose 505 for the previous timestep (e.g., gₜ₋₁). Whenever grasp pose generation module 411 determines it is the last time step 501, the method 1000 proceeds to step 1005.

In sum, techniques are disclosed for robot grasp pose generation using diffusion models. In various embodiments, a model trainer trains a grasp diffusion model using grasp data that is generated via simulations of sampled grasp pose candidates. The grasp diffusion model is a machine learning model that takes as input an object geometry embedding and performs reverse diffusion to generate a set of robot grasp poses. The grasp data for training the grasp diffusion model includes object geometry data and grasp pose data. An object geometry encoder processes the object geometry data and generates an object geometry embedding for each object in the object geometry data. The model trainer uses the grasp diffusion model to process the object geometry embedding and performs forward diffusion steps to generate a predicted noise. During the forward diffusion steps, the model trainer adds noise to a grasp pose included in the grasp pose data and generates a noisy grasp pose at each forward diffusion time step. In some embodiments, the grasp diffusion model processes the noisy grasp pose, the time step, and object geometry embedding and generates a predicted noise. A loss calculator compares the predicted noise with the added noise and computes a first loss. The model trainer updates the parameters of the grasp diffusion model based on the first loss until one or more stopping criteria are met. In some embodiments, a grasp generation module uses the trained grasp diffusion model to process the object geometry data and generate one or more predicted grasp poses. A simulator simulates the predicted grasp poses and generates corresponding grasp pose labels, such as successful grasp pose or unsuccessful grasp pose. The grasp generator then stores the predicted grasp poses and the grasp pose labels in on-generator grasp pose data. The on-generator grasp pose data and the grasp data are stored in augmented grasp pose data. In some embodiments, the model trainer trains a grasp discriminator model based on the augmented grasp data and the trained grasp diffusion model. The grasp discriminator model is a machine learning model that processes an object geometry embedding and grasp poses output by the grasp diffusion model and generates scores for each of the grasp poses. During the training of the grasp discriminator model, the object geometry encoder processes the object geometry data included in the augmented grasp data and generates an object geometry embedding. The grasp discrimination model processes the object geometry embedding and a grasp pose included in the grasp pose data and on-generator grasp pose data and generates a predicted grasp pose label. The loss calculator compares the predicted grasp pose label with a corresponding grasp pose label included in the augmented grasp data to compute a second loss. The model trainer then iteratively updates the parameters of the grasp discriminator model based on the second loss until one or more stopping criteria are met. Once both the grasp diffusion model and the grasp discriminator model are trained, the trained grasp diffusion model and the trained grasp discriminator model can be used by a robot control application to cause a robot to grasp an object.

In some embodiments, the robot control application uses the grasp discriminator model and the grasp diffusion model to process sensor data and generate a grasp robot plan for controlling a robot. The robot control application includes a sensor data processing module, the object geometry encoder, a grasp pose generation module, and a motion planning module. The grasp pose generation module includes the grasp diffusion model and the grasp discriminator model. The sensor data processing module processes the sensor data and generates object geometry data. The object geometry encoder processes the object geometry data and generates an object geometry embedding. The grasp pose generation module then performs reverse diffusion using the grasp diffusion model to generate a set of grasp poses based on the object geometry embedding. At each reverse diffusion time step, the grasp diffusion model processes a noisy grasp pose, the time step, and the object geometry embedding to generate a predicted noise. In some embodiments, the grasp diffusion model includes, without limitation, a position encoder, a multi-layer perceptron, and one or more attention layers. The position encoder is a machine learning model, which processes the time step and generates a time step embedding. The multi-layer perceptron processes the noisy grasp pose and generates noisy grasp pose embedding. The one or more attention layers process the time step embedding, the noisy grasp pose, and the object geometry embedding and generate predicted noise. The foregoing is repeated for a number of time steps to generate successively less noise, until grasp poses are generated. The grasp pose generation module then uses the grasp discriminator model 122 to filter out the grasp poses with low scores, generating filtered grasp poses. The motion planning module processes the filtered grasp poses and generates a grasp robot plan. Then, the robot control application generates one or more controls based on the grasp robot plan and causes the robot to grasp an object based on the grasp robot plan.

At least one technical advantage of the disclosed techniques relative to the prior art is that the disclosed techniques permit scalable, general-purpose grasp pose generation in diverse environments without requiring strong assumptions about object geometry, gripper type, or scene composition. The disclosed techniques use a grasp diffusion model conditioned on object geometry derived from single-view point clouds, which removes the need for multi-view scans or complete 3D mesh reconstructions and allows grasp poses to be generated in cluttered or partially occluded environments. In addition, the disclosed techniques generalize across various gripper modalities, including suction-based, articulated grippers, and/or the like. Furthermore, the disclosed techniques eliminate reliance on full-scene simulation or instance segmentation during runtime by focusing on object-centric modeling, permitting more efficient and modular deployment in real-world robotic systems. The disclosed techniques use a grasp discriminator model to filter out low-likelihood or collision-prone grasp poses, improving grasp reliability without requiring manually defined heuristics. These technical advantages provide one or more technological improvements over prior art approaches.
1. In some embodiments, a computer-implemented method for controlling a robot to grasp an object comprises receiving sensor data from one or more sensors, generating, based on the sensor data and using a first trained machine learning model, one or more grasp poses, selecting, from the one or more grasp poses and using a first trained machine learning model, one or more filtered grasp poses, generating, based on the one or more filtered grasp poses, a grasping plan, and causing the robot to grasp the object based on the grasping plan.
2. The computer-implemented method of clause 1, further comprising generating, based on the sensor data, an object geometry embedding, wherein generating the one or more grasp poses and selecting the one or more filtered grasp poses are based on the object geometry embedding.
3. The computer-implemented method of clauses 1 or 2, wherein generating the object geometry embedding comprises generating, based on the sensor data and using an encoder, object geometry data, and generating, based on the object geometry data, the object geometry embedding.
4. The computer-implemented method of any of clauses 1-3, wherein the first trained machine learning model comprises a denoising diffusion probabilistic model (DDPM).
5. The computer-implemented method of any of clauses 1-4, wherein generating the one or more grasp poses comprises, for each iteration included in one or more iterations of a reverse diffusion technique generating, based on a time step and using an encoder, a time step embedding, generating, based on a noisy grasp pose and using a third machine learning model, a noisy grasp pose embedding, and generating, based on an object geometry embedding, the time step embedding, and the noisy grasp pose embedding, a predicted noise.
6. The computer-implemented method of any of clauses 1-5, wherein at least one of the encoder or the third machine learning model comprises a multilayer perceptron.
7. The computer-implemented method of any of clauses 1-6, wherein selecting the one or more filtered grasp poses comprises generating, based on the one or more grasp poses and using the first trained machine learning model, one or more predicted grasp pose scores, ranking, based on the one or more predicted grasp pose scores, each grasp pose included in the one or more grasp poses to generate one or more ranked grasp poses, and selecting, based on the one or more ranked grasp poses, the one or more filtered grasp poses.
8. The computer-implemented method of any of clauses 1-7, wherein the one or more filtered grasp poses are selected based on one or more highest scores associated with the one or more filtered grasp poses or based on a threshold.
9. The computer-implemented method of any of clauses 1-8, wherein generating the grasping plan comprises determining, for each filtered grasp pose included in the one or more filtered grasp poses, at least one of kinematic feasibility or one or more collision constraints.
10. The computer-implemented method of any of clauses 1-9, further comprising performing, based on grasp data, one or more operations to train a first untrained machine learning model to generate the first trained machine learning model, wherein the first trained machine learning model is trained to generate a predicted noise, performing, based on the grasp data, the first trained machine learning model, and a simulator, one or more operations to generate augmented grasp data, and performing, based on the augmented grasp data, one or more operations to train a second untrained machine learning model to generate the second trained machine learning model, wherein the second trained machine learning model is trained to generate a predicted grasp pose score.
11. In some embodiments, one or more non-transitory computer readable media store instructions that, when executed by one or more processors, cause the one or more processors to perform the steps of receiving sensor data from one or more sensors, generating, based on the sensor data and using a first trained machine learning model, one or more grasp poses, selecting, from the one or more grasp poses and using a first trained machine learning model, one or more filtered grasp poses, generating, based on the one or more filtered grasp poses, a grasping plan, and causing the robot to grasp the object based on the grasping plan.
12. The one or more non-transitory computer-readable media of clause 11, wherein generating the grasping plan comprises selecting a filtered grasp pose included in the one more filtered grasp poses that is associated with a lowest-cost trajectory.
13. The one or more non-transitory computer-readable media of clauses 11 or 12, wherein generating the one or more grasp poses comprises, for each iteration included in one or more iterations of a reverse diffusion technique generating, based on a time step and using an encoder, a time step embedding, generating, based on a noisy grasp pose and using a third machine learning model, a noisy grasp pose embedding, and generating, based on an object geometry embedding, the time step embedding, and the noisy grasp pose embedding, a predicted noise.
14. The one or more non-transitory computer-readable media of any of clauses 11-13, wherein selecting the one or more filtered grasp poses comprises generating, based on the one or more grasp poses and using the first trained machine learning model, one or more predicted grasp pose scores, ranking, based on the one or more predicted grasp pose scores, each grasp pose included in the one or more grasp poses to generate one or more ranked grasp poses, and selecting, based on the one or more ranked grasp poses, the one or more filtered grasp poses.
15. The one or more non-transitory computer-readable media of any of clauses 11-14, wherein the one or more predicted grasp scores include at least one of a continuous value between zero and one representing a confidence in a successful grasp, a grasp success probability, or a binary grasp success or failure prediction.
16. The one or more non-transitory computer-readable media of any of clauses 11-15, wherein the one or more grasp poses include a rigid body transformation in the Special Euclidean group in three dimensions (SE(3)), and wherein the rigid body transformation includes a rotation component in the Special Orthogonal group in three dimensions (SO(3)) and a translation component in three-dimensional Euclidean space.
17. The one or more non-transitory computer-readable media of any of clauses 11-16, wherein the one or more filtered grasp poses are selected based on one or more highest scores associated with the one or more filtered grasp poses or based on a threshold.
18. The one or more non-transitory computer-readable media of any of clauses 11-17, wherein generating the grasping plan comprises determining, for each filtered grasp pose included in the one or more filtered grasp poses, at least one of kinematic feasibility or one or more collision constraints.
19. The one or more non-transitory computer-readable media of any of clauses 11-18, wherein the instructions, when executed by the one or more processors, further cause the one or more processors to perform the steps of performing, based on grasp data, one or more operations to train a first untrained machine learning model to generate the first trained machine learning model, wherein the first trained machine learning model is trained to generate a predicted noise, performing, based on the grasp data, the first trained machine learning model, and a simulator, one or more operations to generate augmented grasp data, and performing, based on the augmented grasp data, one or more operations to train a second untrained machine learning model to generate the second trained machine learning model, wherein the second trained machine learning model is trained to generate a predicted grasp pose score.
20. In some embodiments, a system comprises one or more memories storing instructions, and one or more processors that are coupled to the one or more memories and, when executing the instructions, are configured to receive sensor data from one or more sensors, generate, based on the sensor data and using a first trained machine learning model, one or more grasp poses, select, from the one or more grasp poses and using a first trained machine learning model, one or more filtered grasp poses, generate, based on the one or more filtered grasp poses, a grasping plan, and cause the robot to grasp the object based on the grasping plan.
1. In some embodiments, a computer-implemented method for training a robot grasp diffusion model comprises performing, based on grasp data that includes one or more first robot grasp poses, one or more operations to train an untrained diffusion model to generate a trained diffusion model, generating, using the trained diffusion model, one or more second robot grasp poses, simulating the one or more second robot grasp poses to generate one or more labels indicating if the one or more second robot grasp poses are successful robot grasp poses, and performing, based on the one or more second robot grasp poses and the one or more labels, one or more operations to train an untrained machine learning model to generate a trained machine learning model, wherein the trained diffusion model and the trained machine learning model are used to process sensor data to generate a robot grasp plan for causing a robot to perform at least part of a task.
2. The computer-implemented method of clause 1, wherein the one or more first robot grasp poses include at least one of one or more grasp poses for an antipodal gripper or one or more grasp poses for a suction-based gripper.
3. The computer-implemented method of clauses 1 or 2, wherein performing the one or more operations to train the untrained diffusion model to generate the trained diffusion model comprises generating, based on object geometry data included in the grasp data and using an encoder, an object geometry embedding, performing, based on the object geometry embedding and a third robot grasp pose, one or more forward diffusion steps using the untrained diffusion model to generate a predicted noise, wherein the third robot grasp pose is generated by adding noise to a first robot grasp pose included in the one or more robot grasp poses, calculating, based on the predicted noise and the noise, a loss, and updating, based on the loss, one or more parameters of the untrained diffusion model.
4. The computer-implemented method of any of clauses 1-3, wherein the loss comprises a denoising loss that measures an L2 norm of a difference between the predicted noise and the noise.
5. The computer-implemented method of any of clauses 1-4, wherein calculating the loss comprises at least one of calculating a first loss for a rotation component of the first robot grasp pose or calculating a second loss for a translation component of the first robot grasp pose.
6. The computer-implemented method of any of clauses 1-5, wherein performing the one or more operations to train the untrained machine learning model is further based on the one or more first robot grasp poses.
7. The computer-implemented method of any of clauses 1-6, wherein generating the one or more second robot grasp poses comprises performing at least one of one or more first denoising steps using the trained diffusion model to generate a translation component of the one or more second robot grasp poses or one or more second denoising steps using the trained diffusion model to generate a translation component of the one or more second robot grasp poses.
8. The computer-implemented method of any of clauses 1-7, wherein the one or more labels include at least one of a binary label indicating a success or a failure associated with a second robot grasp pose included in the one or more second robot grasp poses, or a continuous-valued score reflecting at least one of a grasp stability or one or more contact force margins associated with a second robot grasp pose included in the one or more second robot grasp poses.
9. The computer-implemented method of any of clauses 1-8, wherein performing the one or more operations to train the untrained machine learning model to generate the trained machine learning model comprises generating, based on object geometry data and using an encoder, an object geometry embedding, generating, based on the object geometry embedding, a third robot grasp pose, generating, based on the third robot gasp pose and using the untrained machine learning model, a predicted grasp pose score, calculating, based on a first label included in the one or more labels and the predicted grasp pose score, a loss, and updating, based on the loss, one or more parameters of the untrained machine learning model.
10. The computer-implemented method of any of clauses 1-9, wherein the loss comprises a binary cross-entropy loss measuring a divergence between the predicted grasp score and the first label.
11. In some embodiments, one or more non-transitory computer readable media store instructions that, when executed by one or more processors, cause the one or more processors to perform the steps of performing, based on grasp data that includes one or more first robot grasp poses, one or more operations to train an untrained diffusion model to generate a trained diffusion model, generating, using the trained diffusion model, one or more second robot grasp poses, simulating the one or more second robot grasp poses to generate one or more labels indicating if the one or more second robot grasp poses are successful robot grasp poses, and performing, based on the one or more second robot grasp poses and the one or more labels, one or more operations to train an untrained machine learning model to generate a trained machine learning model, wherein the trained diffusion model and the trained machine learning model are used to process sensor data to generate a robot grasp plan for causing a robot to perform at least part of a task.
12. The one or more non-transitory computer-readable media of clause 11, wherein performing the one or more operations to train the untrained diffusion model to generate the trained diffusion model comprises generating, based on object geometry data included in the grasp data and using an encoder, an object geometry embedding, performing, based on the object geometry embedding and a third robot grasp pose, one or more forward diffusion steps using the untrained diffusion model to generate a predicted noise, wherein the third robot grasp pose is generated by adding noise to a first robot grasp pose included in the one or more robot grasp poses, calculating, based on the predicted noise and the noise, a loss, and updating, based on the loss, one or more parameters of the untrained diffusion model.
13. The one or more non-transitory computer-readable media of clauses 11 or 12, wherein generating the one or more second robot grasp poses comprises performing at least one of one or more first denoising steps using the trained diffusion model to generate a translation component of the one or more second robot grasp poses or one or more second denoising steps using the trained diffusion model to generate a translation component of the one or more second robot grasp poses.
14. The one or more non-transitory computer-readable media of any of clauses 11-13, wherein the one or more labels include at least one of a binary label indicating a success or a failure associated with a second robot grasp pose included in the one or more second robot grasp poses, or a continuous-valued score reflecting at least one of a grasp stability or one or more contact force margins associated with a second robot grasp pose included in the one or more second robot grasp poses.
15. The one or more non-transitory computer-readable media of any of clauses 11-14, wherein performing the one or more operations to train the untrained machine learning model to generate the trained machine learning model comprises generating, based on object geometry data and using an encoder, an object geometry embedding, generating, based on the object geometry embedding, a third robot grasp pose, generating, based on the third robot gasp pose and using the untrained machine learning model, a predicted grasp pose score, calculating, based on a first label included in the one or more labels and the predicted grasp pose score, a loss, and updating, based on the loss, one or more parameters of the untrained machine learning model.
16. The one or more non-transitory computer-readable media of any of clauses 11-15, wherein the loss comprises a binary cross-entropy loss measuring a divergence between the predicted grasp score and the first label.
17. The one or more non-transitory computer-readable media of any of clauses 11-16, wherein the loss comprises a first loss penalizing a confident incorrect grasp pose score generated by the untrained machine learning model more than a correct grasp pose score generated by the untrained machine learning model
18. The one or more non-transitory computer-readable media of any of clauses 11-17, wherein calculating the loss comprises calculating one or more first losses over one or more batches of grasp pose scores, and calculating, based on the one or more first losses, an average loss.
19. The one or more non-transitory computer-readable media of any of clauses 11-18, wherein the one or more labels include at least one of one or more positive robot grasp labels or one or more negative robot grasp labels.
20. In some embodiments, a system comprises one or more memories storing instructions, and one or more processors that are coupled to the one or more memories and, when executing the instructions, are configured to perform, based on grasp data that includes one or more first robot grasp poses, one or more operations to train an untrained diffusion model to generate a trained diffusion model, generate, using the trained diffusion model, one or more second robot grasp poses, simulate the one or more second robot grasp poses to generate one or more labels indicating if the one or more second robot grasp poses are successful robot grasp poses, and perform, based on the one or more second robot grasp poses and the one or more labels, one or more operations to train an untrained machine learning model to generate a trained machine learning model, wherein the trained diffusion model and the trained machine learning model are used to process sensor data to generate a robot grasp plan for causing a robot to perform at least part of a task.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot to grasp an object, the method comprising:
receiving sensor data from one or more sensors;
generating, based on the sensor data and using a first trained machine learning model, one or more grasp poses;
selecting, from the one or more grasp poses and using a first trained machine learning model, one or more filtered grasp poses;
generating, based on the one or more filtered grasp poses, a grasping plan; and
causing the robot to grasp the object based on the grasping plan.

2. The computer-implemented method of claim 1, further comprising generating, based on the sensor data, an object geometry embedding, wherein generating the one or more grasp poses and selecting the one or more filtered grasp poses are based on the object geometry embedding.

3. The computer-implemented method of claim 2, wherein generating the object geometry embedding comprises:
generating, based on the sensor data and using an encoder, object geometry data; and
generating, based on the object geometry data, the object geometry embedding.

4. The computer-implemented method of claim 1, wherein the first trained machine learning model comprises a denoising diffusion probabilistic model (DDPM).

5. The computer-implemented method of claim 1, wherein generating the one or more grasp poses comprises, for each iteration included in one or more iterations of a reverse diffusion technique:
generating, based on a time step and using an encoder, a time step embedding;
generating, based on a noisy grasp pose and using a third machine learning model, a noisy grasp pose embedding; and
generating, based on an object geometry embedding, the time step embedding, and the noisy grasp pose embedding, a predicted noise.

6. The computer-implemented method of claim 5, wherein at least one of the encoder or the third machine learning model comprises a multilayer perceptron.

7. The computer-implemented method of claim 1, wherein selecting the one or more filtered grasp poses comprises:
generating, based on the one or more grasp poses and using the first trained machine learning model, one or more predicted grasp pose scores;
ranking, based on the one or more predicted grasp pose scores, each grasp pose included in the one or more grasp poses to generate one or more ranked grasp poses; and
selecting, based on the one or more ranked grasp poses, the one or more filtered grasp poses.

8. The computer-implemented method of claim 1, wherein the one or more filtered grasp poses are selected based on one or more highest scores associated with the one or more filtered grasp poses or based on a threshold.

9. The computer-implemented method of claim 1, wherein generating the grasping plan comprises determining, for each filtered grasp pose included in the one or more filtered grasp poses, at least one of kinematic feasibility or one or more collision constraints.

10. The computer-implemented method of claim 1, further comprising:
performing, based on grasp data, one or more operations to train a first untrained machine learning model to generate the first trained machine learning model, wherein the first trained machine learning model is trained to generate a predicted noise;
performing, based on the grasp data, the first trained machine learning model, and a simulator, one or more operations to generate augmented grasp data; and
performing, based on the augmented grasp data, one or more operations to train a second untrained machine learning model to generate the second trained machine learning model, wherein the second trained machine learning model is trained to generate a predicted grasp pose score.

11. One or more non-transitory computer readable media storing instructions that, when executed by one or more processors, cause the one or more processors to perform the steps of:
receiving sensor data from one or more sensors;
generating, based on the sensor data and using a first trained machine learning model, one or more grasp poses;
selecting, from the one or more grasp poses and using a first trained machine learning model, one or more filtered grasp poses;
generating, based on the one or more filtered grasp poses, a grasping plan; and
causing the robot to grasp the object based on the grasping plan.

12. The one or more non-transitory computer-readable media of claim 11, wherein generating the grasping plan comprises selecting a filtered grasp pose included in the one more filtered grasp poses that is associated with a lowest-cost trajectory.

13. The one or more non-transitory computer-readable media of claim 11, wherein generating the one or more grasp poses comprises, for each iteration included in one or more iterations of a reverse diffusion technique:
generating, based on a time step and using an encoder, a time step embedding;
generating, based on a noisy grasp pose and using a third machine learning model, a noisy grasp pose embedding; and
generating, based on an object geometry embedding, the time step embedding, and the noisy grasp pose embedding, a predicted noise.

14. The one or more non-transitory computer-readable media of claim 11, wherein selecting the one or more filtered grasp poses comprises:
generating, based on the one or more grasp poses and using the first trained machine learning model, one or more predicted grasp pose scores;
ranking, based on the one or more predicted grasp pose scores, each grasp pose included in the one or more grasp poses to generate one or more ranked grasp poses; and
selecting, based on the one or more ranked grasp poses, the one or more filtered grasp poses.

15. The one or more non-transitory computer-readable media of claim 14, wherein the one or more predicted grasp scores include at least one of a continuous value between zero and one representing a confidence in a successful grasp, a grasp success probability, or a binary grasp success or failure prediction.

16. The one or more non-transitory computer-readable media of claim 11, wherein the one or more grasp poses include a rigid body transformation in the Special Euclidean group in three dimensions (SE(3)), and wherein the rigid body transformation includes a rotation component in the Special Orthogonal group in three dimensions (SO(3)) and a translation component in three-dimensional Euclidean space.

17. The one or more non-transitory computer-readable media of claim 11, wherein the one or more filtered grasp poses are selected based on one or more highest scores associated with the one or more filtered grasp poses or based on a threshold.

18. The one or more non-transitory computer-readable media of claim 11, wherein generating the grasping plan comprises determining, for each filtered grasp pose included in the one or more filtered grasp poses, at least one of kinematic feasibility or one or more collision constraints.

19. The one or more non-transitory computer-readable media of claim 11, wherein the instructions, when executed by the one or more processors, further cause the one or more processors to perform the steps of:
performing, based on grasp data, one or more operations to train a first untrained machine learning model to generate the first trained machine learning model, wherein the first trained machine learning model is trained to generate a predicted noise;
performing, based on the grasp data, the first trained machine learning model, and a simulator, one or more operations to generate augmented grasp data; and
performing, based on the augmented grasp data, one or more operations to train a second untrained machine learning model to generate the second trained machine learning model, wherein the second trained machine learning model is trained to generate a predicted grasp pose score.

20. A system comprising:
one or more memories storing instructions, and
one or more processors that are coupled to the one or more memories and, when executing the instructions, are configured to:
receive sensor data from one or more sensors,
generate, based on the sensor data and using a first trained machine learning model, one or more grasp poses,
select, from the one or more grasp poses and using a first trained machine learning model, one or more filtered grasp poses,
generate, based on the one or more filtered grasp poses, a grasping plan, and
cause the robot to grasp the object based on the grasping plan.
